(19) United States
(12) Patent Application Publication
(10) Pub. No.: US 2012/0268493 A1
(43) Pub. Date: Oct. 25, 2012

(54) INFORMATION PROCESSING SYSTEM FOR AUGMENTED REALITY

(75) Inventor: Takeshi HAYAKAWA, Kyoto (JP)

(73) Assignee: NINTENDO CO., LTD., Kyoto (JP)

(21) Appl. No.: 13/448,603

(22) Filed: Apr. 17, 2012

(30) Foreign Application Priority Data
Apr. 22, 2011 (JP) 2011-096619

(51) Int. Cl. G09G 5/00

(52) U.S. Cl. 345/633

(57) ABSTRACT

An example of an information processing system according to a present disclosure controls a single virtual object based on a plurality of pieces of real object information including posture information that indicates respective postures of a plurality of real objects in order to perform control of a virtual object in wider variations when controlling the virtual object using a so-called AR marker.

### CROSS-REFERENCE TO RELATED APPLICATIONS

This application is based upon and claims the benefit of priority of the prior Japanese Patent Application No. JP2011-096619, filed on Apr. 22, 2011, the entire contents of which are incorporated herein by reference.

### FIELD

The present disclosure relates to an information processing system, an information processing device, an information processing method, and a computer-readable recording medium on which an information processing program is recorded.

### BACKGROUND AND SUMMARY

There are techniques known as augmented reality (AR) for augmentatively displaying various types of information referred to as virtual objects or the like in a real space.

With conventional augmented reality techniques, a single virtual object augmentatively displayed in a real space is associated with a single marker in a real space captured by a camera. In addition, for example, the virtual object is augmentatively displayed in the real space so as to exist on the associated marker. As described above, with conventional augmented reality techniques, when controlling a virtual object by using a marker in a real space as a reference, the virtual object is controlled based on a position, a posture, and the like of a single associated marker. Therefore, variations in controlling a virtual object augmentatively displayed in a real space are limited.

One example of the information processing system according to the present disclosure is an information processing system comprising a plurality of real objects each having a feature and an information processing device connected to a display device and an imaging device, wherein the feature is a feature which enables at least a posture of the real object with respect to the imaging device to be identified by being captured by the imaging device, and the information processing device includes a captured image acquiring unit which acquires a captured image that is captured by the imaging device, a detecting unit which detects the respective features of the plurality of real objects from the captured image, a real object information acquiring unit which acquires a plurality of pieces of real object information including posture information that indicates respective postures of the plurality of real objects, based on the detected features, a virtual object control unit which controls a single virtual object in a virtual space based on the plurality of pieces of real object information, and a display control unit which causes the display device to display an image including at least the single virtual object.

In the present disclosure, specific examples of a feature that enables a posture of a real object with respect to an imaging device to be identified include a so-called AR marker and codes such as a two-dimensional bar code.

With the information processing system according to the present disclosure, by comprising the respective units described above, a single virtual object is controlled based on a plurality of pieces of real object information including posture information that indicates respective postures of a plurality of real objects. Therefore, according to the present disclosure, when controlling a virtual object using a so-called AR marker, control of the virtual object can be performed in wider variations.

In addition, the information processing device may further include a relative posture information acquiring unit which acquires relative posture information indicating a relative posture relationship among the plurality of real objects from the plurality of pieces of real object information, and the virtual object control unit may control the single virtual object based on the relative posture information.

In the present disclosure, relative posture information indicating a relative posture relationship among a plurality of real objects is acquired by the relative posture information acquiring unit. As a result, according to the present disclosure, since a virtual object can be controlled based on such relative posture information, control of the virtual object can be performed in wider variations.

Furthermore, the virtual object control unit may change a value of a parameter related to a state of the single virtual object based on the relative posture information.

According to the present disclosure, since control of a virtual object is performed by changing a value of a parameter, the virtual object can be controlled by a simple method.

Moreover, the parameter related to the state of the single virtual object whose value is changed by the virtual object control unit may at least include a parameter related to a position variation of the single virtual object in the virtual space.

According to the present disclosure, a position variation of a virtual object in a virtual space can be controlled.

In addition, the virtual object control unit may vary a relative position of the single virtual object with respect to the virtual space based on a value of the parameter related to the position variation of the single virtual object.

According to the present disclosure, a position variation of a virtual object is realized by a variation of a relative position of the virtual object in relation to a virtual space. Therefore, according to the present disclosure, a position variation of a virtual object can be realized by a flexible method.

Furthermore, the parameter related to the position variation of the single virtual object in the virtual space whose value is changed by the virtual object control unit may at least include parameters related to a movement direction and a movement speed of the single virtual object.

According to the present disclosure, a movement of a virtual object in a virtual space can be controlled.

Moreover, the relative posture information acquiring unit may acquire the relative posture information including information related to a similarity of posture between two real objects among the plurality of real objects.

According to the present disclosure, a single virtual object can be controlled based on a similarity of posture between two real objects among a plurality of real objects. Therefore, according to the present disclosure, control of the virtual object can be performed in wider variations.

In addition, the relative posture information acquiring unit may acquire the relative posture information including information related to a difference in posture between two real objects among the plurality of real objects.

According to the present disclosure, a single virtual object can be controlled based on a difference in posture between two real objects among a plurality of real objects. Therefore, according to the present disclosure, control of the virtual object can be performed in wider variations.

Furthermore, the feature may be a feature which enables a position and a posture of the real object with respect to the imaging device to be identified by being captured by the imaging device, the feature being attached to the real object, and the real object information acquiring unit may acquire a plurality of pieces of real object information including position/posture information that indicates respective positions and postures of the plurality of real objects, based on the detected feature.

According to the present disclosure, since a single virtual object can now be controlled based on positions and postures of a plurality of real objects, control of the virtual object can be performed in wider variations.

Moreover, the relative posture information acquiring unit may acquire the relative posture information including information indicating an opposing state identified from positions and postures of at least two real objects among the plurality of real objects.

According to the present disclosure, a single virtual object can be controlled based on information indicating an opposing state identified from positions and postures of at least two real objects among the plurality of real objects. Therefore, according to the present disclosure, control of the virtual object can be performed in wider variations.

In addition, the relative posture information acquiring unit may identify the opposing state using an inner product value of vectors related to postures of two real objects among the at least two real objects and an inner product value of a vector related to a posture of one real object of the two real objects and a relative position vector indicating a relative position relationship of the two real objects.

Furthermore, the virtual object control unit may control, based on the plurality of pieces of real object information, a posture indicated by values of a plurality of parameters related to the posture of the single virtual object and each having a correspondence relationship with each of the plurality of pieces of real object information.

According to the present disclosure, a posture of a single virtual object is controlled based on a plurality of pieces of real object information including posture information that indicates respective postures of a plurality of real objects. Therefore, according to the present disclosure, control of the virtual object can be performed in wider variations.

Moreover, when controlling the single virtual object, the virtual object control unit may change, based on a posture of the single virtual object indicated by the values of the plurality of parameters related to the posture, a value of a parameter which is different from the plurality of parameters related to the posture and which relates to other states.

According to the present disclosure, by controlling a posture of a virtual object, other states of the virtual object can be further controlled. Therefore, according to the present disclosure, control of the virtual object can be performed in wider variations.

In addition, the parameter related to another state may be a parameter related to a position variation in the virtual space.

According to the present disclosure, by controlling a posture of a virtual object, a position variation of the virtual object in a virtual space can be further controlled. Therefore, according to the present disclosure, control of the virtual object can be performed in wider variations.

Furthermore, when the parameter related to another state is a parameter related to a position variation in a virtual space, the virtual object control unit may vary a relative position of the single virtual object with respect to the virtual space based on a value of the parameter related to the position variation of the single virtual object.

Moreover, when the virtual object control unit changes, based on the plurality of pieces of real object information, values of a plurality of parameters which is related to a posture of the single virtual object and which is in a correspondence relationship with each of the plurality of pieces of real object information, the feature may be a feature which enables a position and a posture of the real object with respect to the imaging device to be identified by being captured by the imaging device, and the real object information acquiring unit may acquire a plurality of pieces of real object information including position/posture information that indicates respective positions and postures of the plurality of real objects.

In addition, the information processing device may further include a rendering unit which renders a virtual space image by setting a position and a posture of a virtual camera arranged in a virtual space, arranging, in the virtual space, the single virtual object whose position and posture are determined by the plurality of pieces of real object information, and generating an image of the virtual space as seen from the virtual camera.

Furthermore, the information processing device may further include a display control unit which generates a composite image in which the virtual space image is superimposed on the captured image and which causes a display device to display the composite image.

Moreover, the present disclosure can also be considered as being an information processing method that is executed by a computer. In addition, the present disclosure may be embodied by a recording medium which is readable by a device such as a computer, a machine, or the like and on which an information processing program for causing a computer to execute processes is recorded. In this case, a recording medium that is readable by a computer or the like refers to a medium which accumulates information such as programs by an electric action, a magnetic action, an optical action, a mechanical action, or a chemical action. Furthermore, the information processing device according to the present disclosure may be realized by a plurality of computers or the like configured to be capable of communicating with each other.

### BRIEF DESCRIPTION OF THE DRAWINGS

FIG. 1A is a diagram illustrating a configuration of a game system according to an embodiment;

FIG. 1B is a diagram illustrating a configuration of a game system according to an embodiment;

FIG. 2 is a diagram illustrating an exterior of a game device according to an embodiment;

FIG. 3 is a block diagram illustrating an internal configuration of a game device according to an embodiment;

FIG. 4 is a diagram showing an example of coordinate systems handled by a game system according to an embodiment;

FIG. 5 is a diagram illustrating information retained by a game device according to an embodiment;

FIG. 6A is a diagram for explaining opposing state information according to an embodiment;

FIG. 6B is a diagram for explaining opposing state information according to an embodiment;

FIG. 6C is a diagram for explaining opposing state information according to an embodiment;

FIG. 6D is a diagram for explaining opposing state information according to an embodiment;

FIG. 6E is a diagram for explaining opposing state information according to an embodiment;

FIG. 6F is a diagram for explaining opposing state information according to an embodiment;

FIG. 7 is a block diagram illustrating functions of a game device according to an embodiment;

FIG. 8 is a flow chart illustrating a flow of game processing according to an embodiment;

FIG. 9 is a flow chart illustrating a procedure of a virtual object control related process according to an embodiment;

FIG. 10 is a diagram illustrating information retained by a game device according to a modification;

FIG. 11 is a block diagram illustrating functions of a game device according to a modification;

FIG. 12 is a flow chart illustrating a procedure of a virtual object control related process according to a modification;

FIG. 13A is a diagram showing an application example of a game system according to an embodiment;

FIG. 13B is a diagram showing an application example of a game system according to an embodiment;

FIG. 14A is a diagram showing an application example of a game system according to an embodiment; and

FIG. 14B is a diagram showing an application example of a game system according to an embodiment.

### DETAILED DESCRIPTION OF NON-LIMITING EXAMPLE EMBODIMENTS

Hereinafter, an embodiment (hereinafter, also referred to as “the present embodiment”) of an information processing system, an information processing device, an information processing method, and a computer-readable recording medium on which an information processing program is recorded according to the present disclosure will be described with reference to the drawings. However, the present embodiment described below merely exemplifies the information processing system and the like according to the present disclosure in all aspects, and is not intended to limit the scope of the information processing system and the like according to the present disclosure. When implementing the information processing system and the like according to the present disclosure, specific configurations in accordance with the present embodiment may be adopted as appropriate.

Moreover, data that appears in the present embodiment is described in a natural language (English or the like). However, specifically, the data is specified in a pseudo-language, commands, parameters, a machine language, or the like that can be recognized by a computer.

### §1. System Configuration

[Game System]

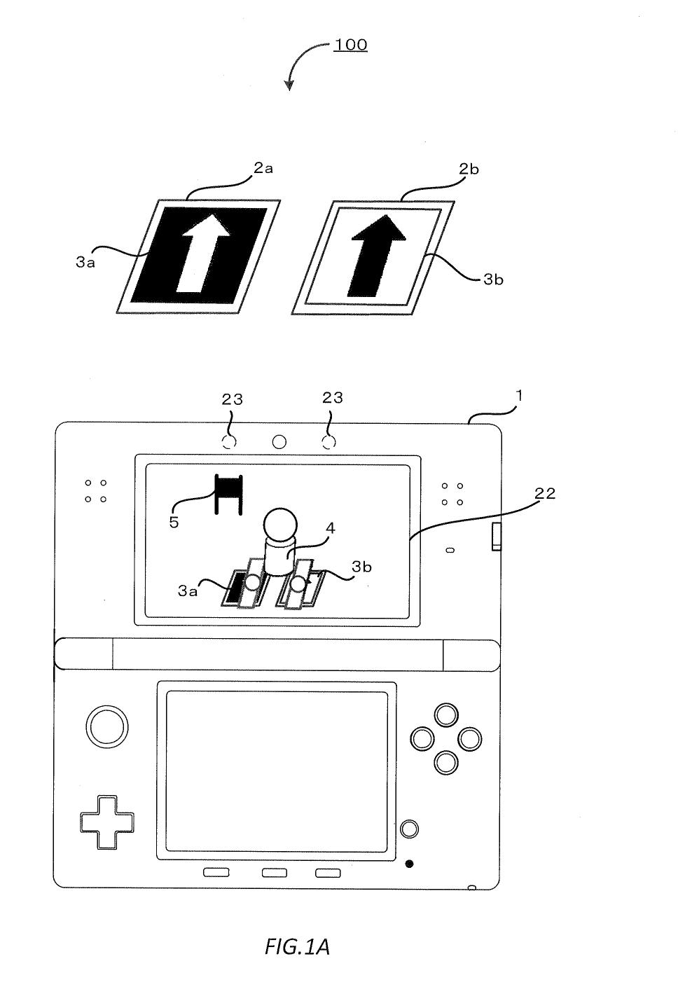

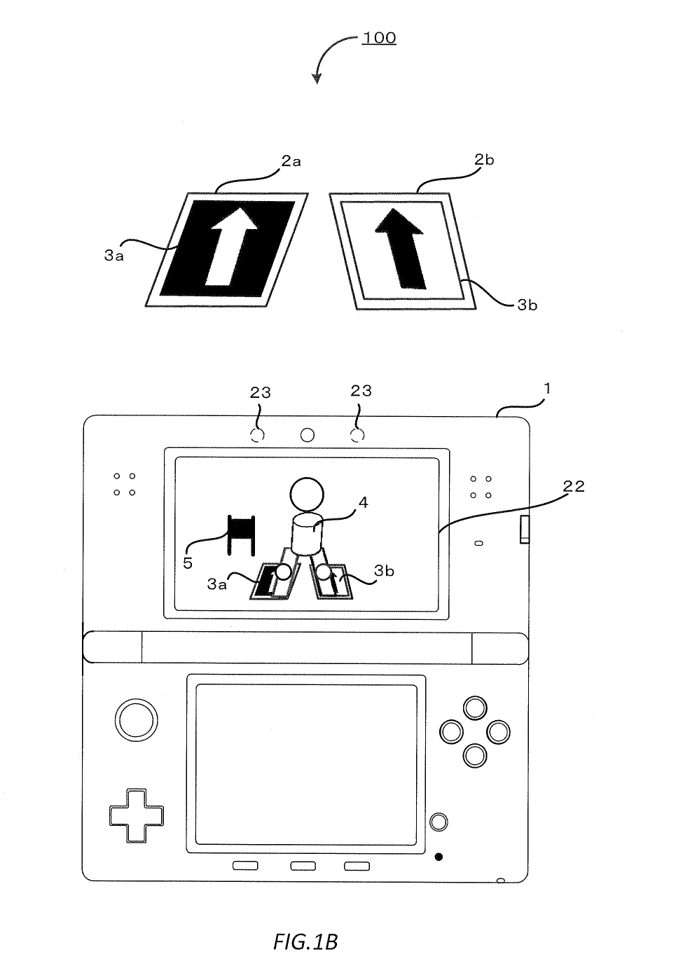

FIGS. 1A and 1B show a configuration example of a game system 100 according to the present embodiment. The game system 100 comprises a game device 1 and a plurality of cards 2a and 2b (however, when types of cards are not distinguished, also simply referred to as “card 2”). For example, the game system 100 provides a player with a ski game such as that shown in FIGS. 1A and 1B. In the ski game provided by the game system 100, a character 4 is continuously displayed on the card 2. In addition, a movement of the character 4 is expressed by a movement of a virtual object (for example, an obstacle 5) other than the character 4 on a screen. The character 4 is controlled by at least a posture of the card 2. In other words, the player causes the character 4 to perform a desired motion by at least changing a posture of the card 2. In the present embodiment, an example is shown in which an information processing system according to the present disclosure is used as a game system. However, an application range of the information processing system according to the present disclosure is not limited to a game system.

The game device 1 comprises a display 22 (hereinafter referred to as an “upper LCD 22”) and a real camera 23 (hereinafter referred to as an “outer imaging unit 23”). The game device 1 functions to synthesize a virtual object in a virtual space rendered using a virtual camera onto a captured image of a real space captured using the real camera 23, and display the synthesized image on the display 22. In the present embodiment, the virtual object is the character 4, the obstacle 5, a background, or the like of the game.

In the game system 100, when an image of the card 2 is captured using the real camera 23 of the game device 1, a virtual object which does not exist in the captured real space but is arranged in a virtual space is displayed on the display 22 of the game device 1. In the example shown in FIGS. 1A and 1B, the character 4 and the obstacle 5 are depicted as virtual objects. The character 4 is a virtual object to be manipulated by the player. In addition, the obstacle 5 is a virtual object which is arranged on the virtual space and which is not the virtual object to be manipulated by the player. Moreover, another example of a virtual object which is arranged on the virtual space and which is not the virtual object to be manipulated by the player is the background or the like. The same description as the obstacle 5 described below applies to these virtual objects. Therefore, hereinafter, virtual objects other than a virtual object to be manipulated by the player will be described by describing the obstacle 5.

With the game system 100 according to the present embodiment, if the player changes at least a posture of the card 2 when the game is in progress, a state of the character 4 displayed on the display 22 of the game device 1 changes. For example, as shown in FIG. 1A, let us assume that the player aligns orientations of the card 2a and the card 2b in a forward direction. Consequently, the character 4 takes a crouching posture and makes a schuss motion. In addition, for example, as shown in FIG. 1B, let us assume that the player arranges the orientations of the card 2a and the card 2b in a shape of an inverted “V” separated at the top. Consequently, the character 4 takes a posture in which hips are extended and makes a snowplow motion. As shown, with the game system 100 according to the present embodiment, the character 4 is controlled by at least postures of the plurality of cards 2.

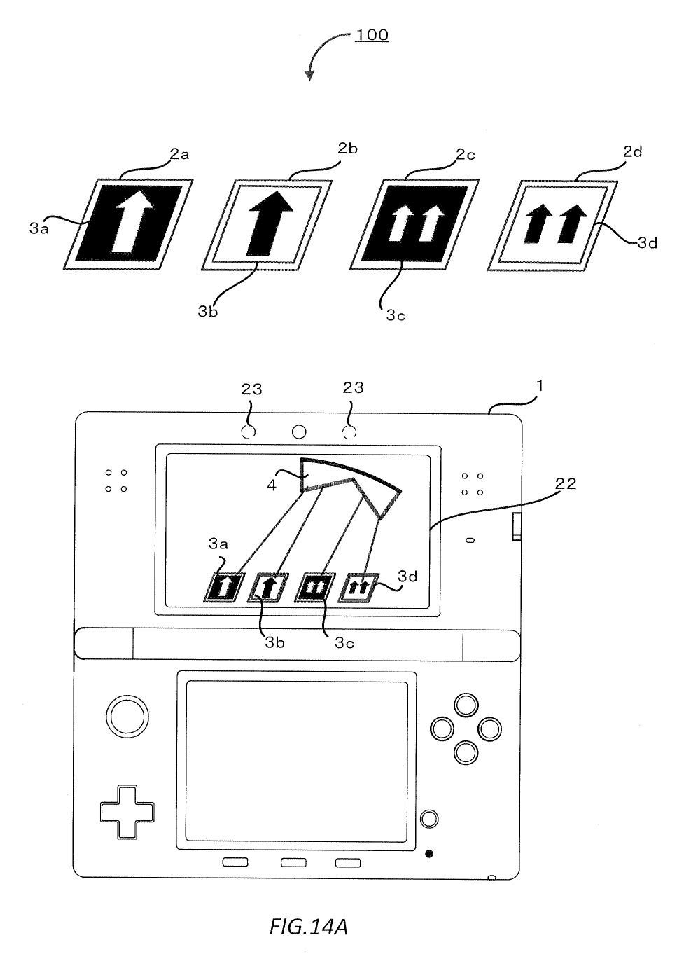

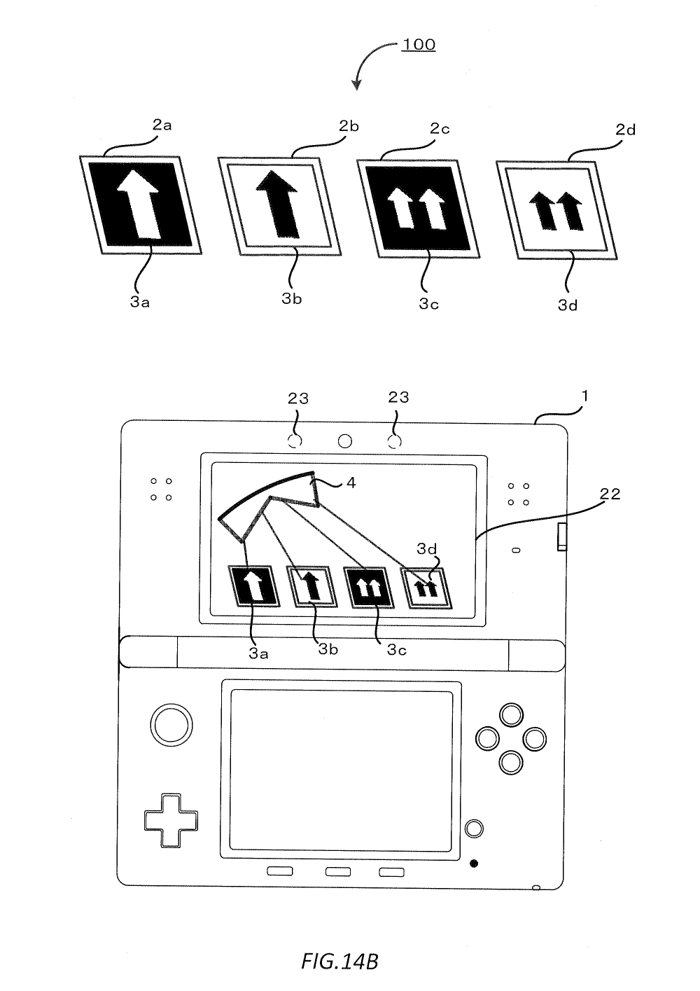

Markers 3a and 3b (however, when types of markers are not distinguished, also simply referred to as “marker 3”) are attached to the cards 2a and 2b using a method such as printing. The marker 3 is an indicator that indicates at least a posture of the card 2. Specifically, the marker 3 is a feature such as a symbol, a letter, a graphic, a picture, or a combination thereof which enables at least a posture of the card 2 with respect to the real camera 23 to be identified by being captured using the real camera 23, the marker 3 being attached to the card 2. In the present embodiment, the game device 1 identifies a posture of the card 2 using the marker 3. Moreover, while only two cards 2 are shown in FIGS. 1A and 1B, there may be three or more cards 2 (refer to FIG. 14A, to be described later). In addition, in FIGS. 1A and 1B, different markers are respectively attached to the cards 2 in order to distinguish the cards 2. However, when there is no need to distinguish the cards 2, a same marker may be attached to the cards 2. Furthermore, indicators that indicate at least a posture of the card 2 is not limited to a marker attached to the card 2. For example, an indicator that indicates at least a posture of the card 2 may be a shape or the like of the card 2 itself.

In the present embodiment, a position at which the character 4 is arranged is determined by positions of the plurality of cards 2 (markers 3) on the display 22 of the game device 1. In the example shown in FIGS. 1A and 1B, a left foot of the character 4 is arranged on the card 2a (marker 3a). In addition, a right foot of the character 4 is arranged on the card 2b (marker 3b). Therefore, the marker 3 according to the present embodiment is also an indicator which enables at least a position of the card 2 with respect to the real camera 23 to be identified by being captured using the real camera 23, the marker 3 being attached to the card 2. However, when positions of the plurality of cards 2 (markers 3) need not be used, the markers 3 may not be indicators capable of identifying positions of the cards 2. For example, a case in which the positions of the plurality of cards 2 (markers 3) need not be used is a case in which the character 4 is arranged regardless of the positions of the plurality of cards 2 (markers 3).

Moreover, in the present embodiment, a position variation of the character 4 in a virtual space is expressed by a change in a relative position of the character 4 with respect to the virtual space. In the ski game according to the present embodiment, the character 4 is always displayed on the card 2. In this case, a position variation of the character 4 in a virtual space is expressed by a variation of a display position of the obstacle 5 displayed on the display 22. However, the information processing system according to the present disclosure is not limited to a form in which the character 4 is always displayed on the card 2 as is the case of the ski game according to the present embodiment (for example, refer to FIGS. 14A and 14B to be described later).

As described above, the game system 100 according to the present embodiment comprises a plurality of cards 2 to which markers 3 are attached and a game device 1 connected to a real camera 23. The marker 3 is a feature which enables at least a posture of the card 2 with respect to the real camera 23 to be identified by being captured using the real camera 23, the marker 3 being attached to the card 2.

The game device 1 acquires a captured image that is captured by the real camera 23. Next, the game device 1 respectively detects a plurality of markers 3 from the captured image. Subsequently, based on the detected markers 3, the game device 1 acquires a plurality of pieces of card information including posture information indicating respective postures of the plurality of cards 2. As a result, the game device 1 controls the character 4 based on the acquired plurality of pieces of card information. In this case, a plurality of pieces of card information means a plurality of items of card information. Each item of card information among the plurality of items of card information includes posture information of the cards 2 which differ from each other.

Moreover, the game device 1 is an example of the information processing device described earlier. The plurality of cards 2 is an example of the plurality of real objects described earlier. The marker 3 is an example of the feature described earlier. The character 4 is an example of the “single virtual object” described earlier. The card information is an example of the real object information described earlier.

[Game Device]

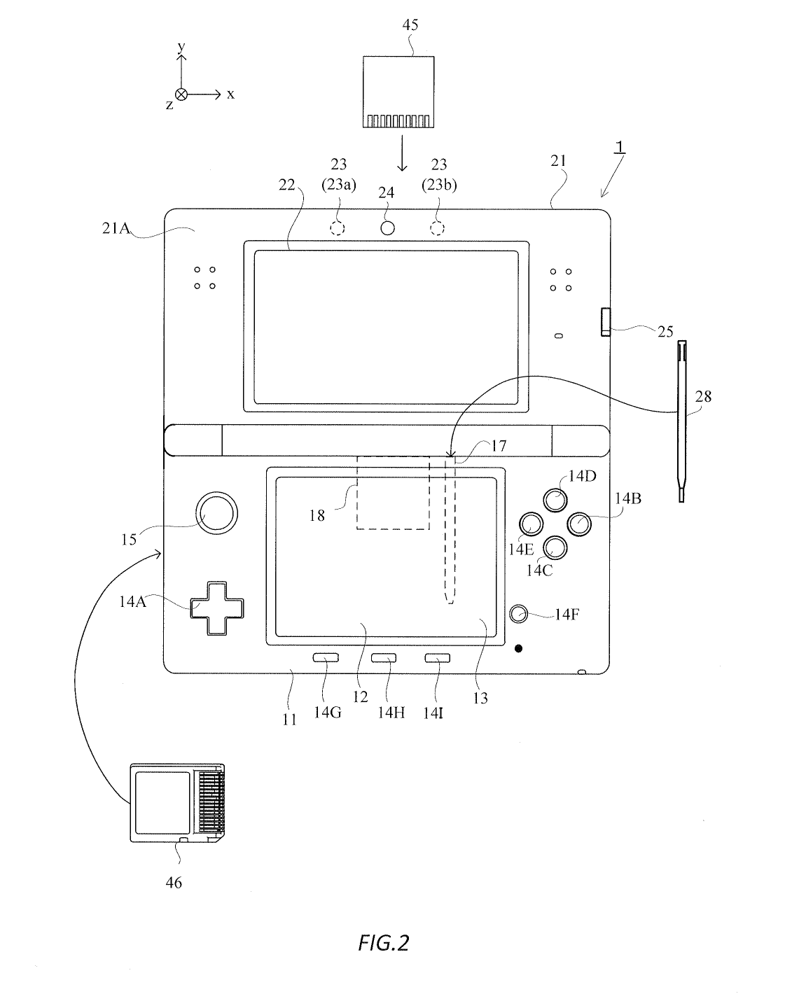

FIG. 2 illustrates an exterior of the game device 1 according to the present embodiment. The game device 1 has a lower housing 11 and an upper housing 21. The lower housing 11 and the upper housing 21 are openably and closably coupled (foldably coupled) to each other by a hinge structure.

The lower housing 11 is provided with a lower LCD (Liquid Crystal Display) 12, a touch panel 13, operating buttons 14A to 14I, an analog stick 15, an insertion slot 17, and an insertion slot 18.

The lower LCD 12 is a display device that displays an image in a planar manner (the image is not stereoscopically viewable). The touch panel 13 is an example of an input device of the game device 1. A stylus 28 used for input to the touch panel 13 is inserted and housed from the insertion slot 17 (depicted by a dotted line in FIG. 2). Moreover, a finger of a user can be used in place of the stylus 28.

The respective operating buttons 14A to 14I are input devices for performing predetermined inputs. Functions corresponding to a program that is executed by the game device 1 are appropriately assigned to the buttons 14A to 14I. For example, an arrow pad 14A is used for performing a selection operation and the like. For example, the respective buttons 14B to 14E are used for performing an enter operation, a cancel operation, and the like. For example, a power button 14F is used for turning on or turning off the game device 1. For example, a select button 14G is used for performing a game interruption operation and the like. For example, a HOME button 14H is used for performing an operation to display a predetermined screen and the like. For example, a start button 14I is used for performing a game start operation and the like. In addition, the analog stick 15 is a device for indicating directions.

An external memory 45 on which a game program is recorded is inserted into the insertion slot 18 (depicted by a dotted line in FIG. 2).

The upper LCD 22, an outer left imaging unit 23a, an outer right imaging unit 23b, an inner imaging unit 24, and a 3D adjustment switch 25 are provided on the upper housing 21.

The upper LCD 22 is a display device which is switchable between a stereoscopic display mode which displays stereoscopically viewable images and a planar display mode which displays images in a planar view (which displays planar view images). The display modes may be switched using the 3D adjustment switch 25.

The inner imaging unit 24 is an imaging unit having an inward normal direction to an inner surface 21A of the upper housing 21 as an imaging direction. The outer left imaging unit 23a and the outer right imaging unit 23b are both imaging units having an outward normal direction opposite to the inner surface 21A as imaging directions. Hereinafter, the outer left imaging unit 23a and the outer right imaging unit 23b will be collectively referred to as an outer imaging unit 23.

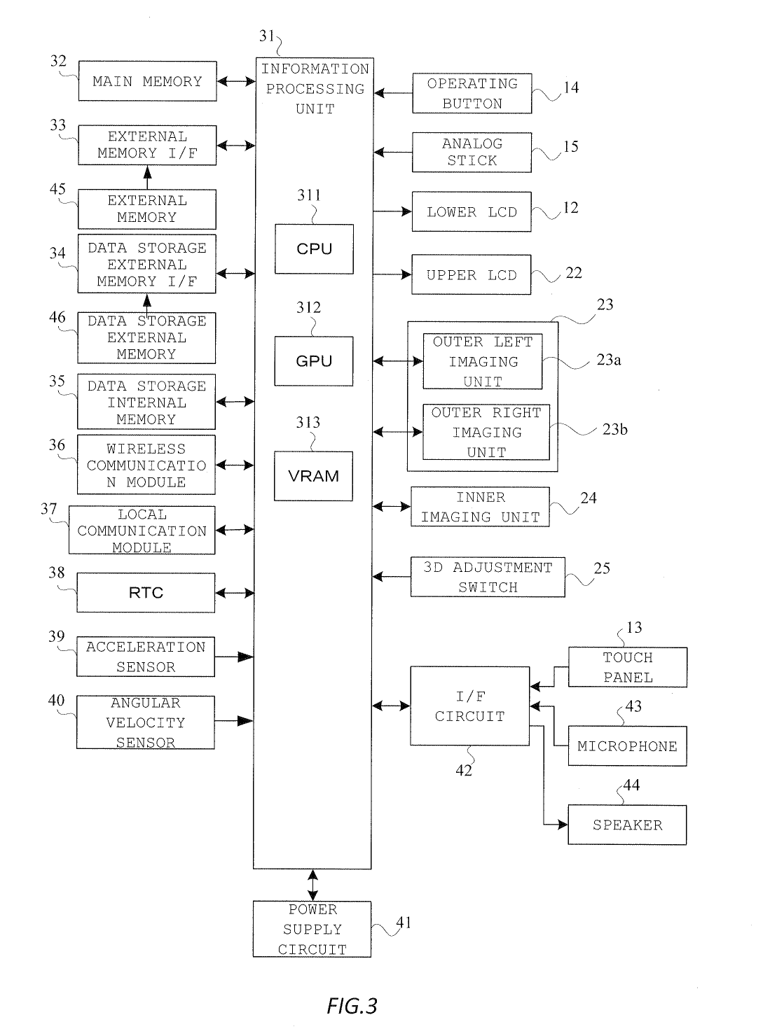

FIG. 3 is a block diagram showing an inner configuration of the game device 1 according to the present embodiment. In addition to the respective units described above, the game device 1 comprises electronic components such as an information processing unit 31, a main memory 32, an external memory interface (external memory I/F) 33, a data storage external memory interface (data storage external memory I/F) 34, a data storage internal memory 35, a wireless communication module 36, a local communication module 37, a real-time clock (RTC) 38, an acceleration sensor 39, an angular velocity sensor 40, a power supply circuit 41 and an interface circuit (I/F circuit) 42. These electronic components are mounted on an electronic circuit board and are accommodated inside the lower housing 11 (or inside the upper housing 21).

The information processing unit 31 comprises a CPU (Central Processing Unit) 311 for executing a predetermined program, a GPU (Graphics Processing Unit) 312 for performing image processing, a VRAM (Video RAM) 313, and the like. The CPU 311 executes predetermined processing by executing a predetermined program stored in a memory in the game device 1 (for example, an external memory 45 connected to the external memory I/F 33 or the data storage internal memory 35). Moreover, the program executed by the CPU 311 of the information processing unit 31 may be acquired from another device by communicating with the other device. The GPU 312 of the information processing unit 31 generates an image in accordance with a command from the CPU 311 of the information processing unit 31 and renders the image in the VRAM 313. The image rendered in the VRAM 313 is outputted to and displayed on the upper LCD 22 and/or the lower LCD 12.

The main memory 32, the external memory I/F 33, the data storage external memory I/F 34, and the data storage internal memory 35 are connected to the information processing unit 31. The external memory I/F 33 is an interface for detachably connecting the external memory 45. In addition, the data storage external memory I/F 34 is an interface for detachably connecting a data storage external memory 46.

The main memory 32 is volatile storage means which is used as a work area or a buffer area of the information processing unit 31 (CPU 311). In other words, the main memory 32 temporarily stores various data, and also temporarily stores a program acquired from the outside (the external memory 45 or other devices and the like). In the present embodiment, for example, a PSRAM (Pseudo-Static Random Access Memory) is used as the main memory 32.

The external memory 45 is non-volatile storage means for storing a program which is executed by the information processing unit 31. For example, the external memory 45 is constituted by a read-only semiconductor memory. When the external memory 45 is connected to the external memory I/F 33, the information processing unit 31 is able to read a program stored in the external memory 45. Predetermined processing is performed by executing the program read by the information processing unit 31.

The data storage external memory 46 is a non-volatile rewriteable memory (for example, a NAND flash memory) and is used to store predetermined data. For example, the data storage external memory 46 is an SD card. The data storage internal memory 35 is constituted by a non-volatile rewriteable memory (for example, a NAND flash memory) and is used to store predetermined data. For example, data and programs downloaded by wireless communication via the wireless communication module 36 are stored in the data storage external memory 46 and the data storage internal memory 35.

The wireless communication module 36 and the local communication module 37 are connected to the information processing unit 31. For example, the wireless communication module 36 has a function of connecting to a wireless LAN by a method conforming to the IEEE 802.11b/g standard. The information processing unit 31 is able to use the wireless communication module 36 to send and receive data to and from other devices via the Internet and to directly perform wireless communication with other game devices 1 in an IEEE 802.11b/g adhoc mode. In addition, the local communication module 37 has a function of performing wireless communication with a game device of the same type by using a predetermined communication method (for example, infrared communication). The information processing unit 31 is able to use the local communication module 37 to send and receive data to and from other game devices 1 of the same type.

The acceleration sensor 39 is connected to the information processing unit 31. The acceleration sensor 39 determines a magnitude of acceleration (linear acceleration) in linear directions along three axial directions. Moreover, the acceleration sensor 39 may be an electrostatic capacitance-type acceleration sensor or an acceleration sensor based on another method. In addition, the acceleration sensor 39 may also be an acceleration sensor which determines acceleration in one axial direction or two axial directions. The information processing unit 31 receives data (acceleration data) indicating the acceleration as determined by the acceleration sensor 39 and calculates a posture and a movement of the game device 1.

The angular velocity sensor 40 is connected to the information processing unit 31. The angular velocity sensor 40 respectively determines an angular velocity created about the three axes of the game device 1, and outputs data indicating the determined angular velocities (angular velocity data) to the information processing unit 31. The information processing unit 31 receives angular velocity data outputted from the angular velocity sensor 40 and calculates a posture and a movement of the game device 1.

The RTC 38 and the power supply circuit 41 are connected to the information processing unit 31. The RTC 38 counts time and outputs a time count to the information processing unit 31. The information processing unit 31 calculates a current time based on the time measured by the RTC 38. The power supply circuit 41 controls power from a power source of the game device 1 (for example, a rechargeable battery accommodated in the lower housing 11), and supplies power to the respective components of the game device 1.

The I/F circuit 42 is connected to the information processing unit 31. A microphone 43, a speaker 44 and the touch panel 13 are connected to the I/F circuit 42. The microphone 43 detects a voice of the user and outputs an audio signal to the I/F circuit 42. The speaker 44 amplifies the audio signal from the I/F circuit 42 using an amplifier (not shown), and outputs sound. The I/F circuit 42 comprises an audio control circuit which controls the microphone 43 and the speaker 44, and a touch panel control circuit which controls the touch panel 13. The audio control circuit performs A/D conversion and D/A conversion on an audio signal, and converts an audio signal into audio data of a predetermined format. In the present embodiment, a resistive film touch panel is used as the touch panel 13. However, the touch panel 13 is not limited to a resistive film touch panel and a touch panel based on any press operation method such as an electrostatic capacitance method can be used. The touch panel control circuit generates a touch position coordinate of the touch panel 13 in a predetermined format based on a signal from the touch panel 13, and outputs the touch position coordinate to the information processing unit 31. By acquiring touch position data, the information processing unit 31 is able to identify a touch position where an input has been made to the touch panel 13.

The operating buttons 14 and the analog stick 15 are connected to the information processing unit 31 and output operating data indicating an input status (whether or not a button is pressed) of the respective operating buttons (for example, 14A to 14I and 15 shown in FIG. 2) to the information processing unit 31. By acquiring operating data from the operating buttons 14 and the analog stick 15, the information processing unit 31 executes processing in accordance with inputs made to the operating buttons 14 and the analog stick 15.

The lower LCD 12 and the upper LCD 22 are connected to the information processing unit 31. The lower LCD 12 and the upper LCD 22 display images according to instructions from the information processing unit 31 (GPU 312). The lower LCD 12 is a display device that displays an image in a planar view (the image is not stereoscopically viewable). For example, the number of pixels of the lower LCD 12 is 320 dots×240 dots (horizontal×vertical). Moreover, while an LCD is used as a display device in the present embodiment, other display devices such as a display device using EL (Electro Luminescence) may also be used. In addition, a display device having a desired resolution can be used as the lower LCD 12.

The upper LCD 22 is a display device which can be stereoscopically viewed with the naked eye. For example, the upper LCD 22 is a lenticular LCD, a parallax barrier LCD, or the like. Accordingly, the upper LCD 22 is capable of displaying a left-eye image and a right-eye image, which are alternatively displayed in a horizontal direction, so as to be respectively viewed separately by the left eye and the right eye. For example, the number of pixels of the upper LCD 22 is 800 dots×240 dots (horizontal×vertical). In the present embodiment, the upper LCD 22 will be described as being a liquid crystal display device. However, the upper LCD 22 is not limited thereto and, for example, a display device using EL may also be used. In addition, a display device having a desired resolution can be used as the upper LCD 22.

The outer imaging unit 23 and the inner imaging unit 24 are connected to the information processing unit 31. The outer imaging unit 23 and the inner imaging unit 24 capture images in accordance with instructions from the information processing unit 31 and output captured image data to the information processing unit 31.

The inner imaging unit 24 comprises an imaging element having a predetermined resolution, and a lens. For example, the imaging element is a CCD (Charge Coupled Device) image sensor or a CMOS (Complementary Metal Oxide Semiconductor) image sensor. The lens may be equipped with a zooming mechanism.

The outer left imaging unit 23a and the outer right imaging unit 23b respectively comprise an imaging element (for example, a CCD image sensor or a CMOS image sensor) having a common predetermined resolution, and a lens. The lens may be equipped with a zooming mechanism. Depending on a program executed by the game device 1, either one of the two outer imaging units (the outer left imaging unit 23a and the outer right imaging unit 23b) can be used independently. In the present embodiment, a description will be given on the assumption that either one of the outer imaging units is used.

The 3D adjustment switch 25 is connected to the information processing unit 31. The 3D adjustment switch 25 sends an electric signal corresponding to a position of a slider to the information processing unit 31.

[Coordinate Systems]

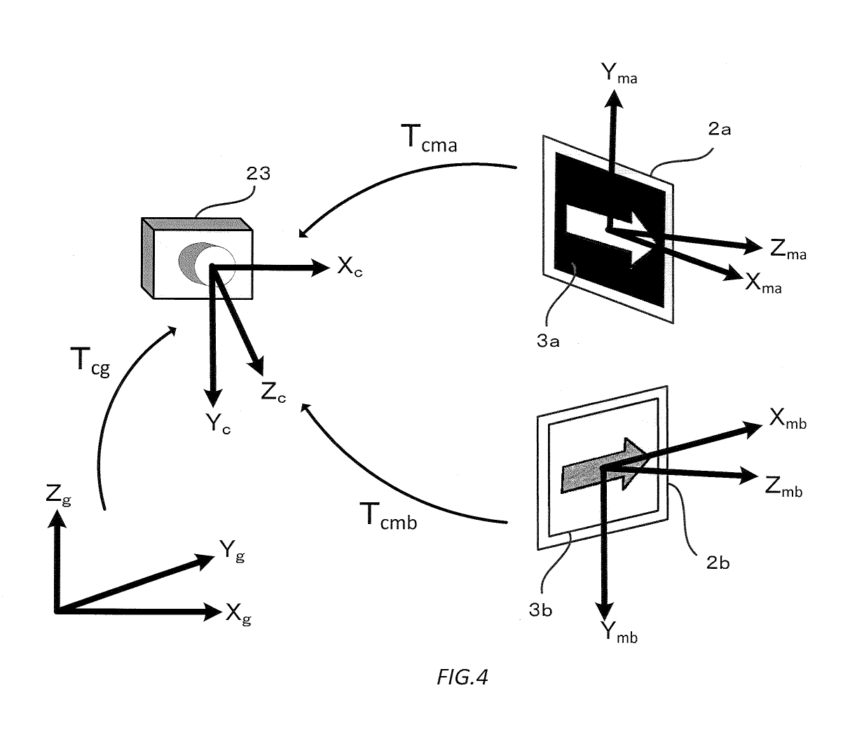

FIG. 4 shows an example of coordinate systems handled by the game system 100 according to the present embodiment. For example, the game system 100 according to the present embodiment handles a marker coordinate system (Xₘ, Yₘ, Zₘ), a virtual space coordinate system (X_{g}, Y_{g}, Z_{g}), a camera coordinate system (X_{c}, Y_{c}, Z_{c}), and a captured image plane coordinate system (Xₚ, Yₚ) (not shown). Moreover, in FIG. 4, a marker coordinate system of the marker 3a is expressed as (Xₘₐ, Yₘₐ, Zₘₐ) and a marker coordinate system of the marker 3b is expressed as (X_{mb}, Y_{mb}, Z_{mb}). However, when marker coordinate systems of the marker 3a and the marker 3b are not distinguished from each other, a coordinate system of the marker 3 will be expressed as (Xₘ, Yₘ, Zₘ).

The marker coordinate system (Xₘ, Yₘ, Zₘ) is a coordinate system that is set with reference to the marker 3. For example, the marker coordinate system is a coordinate system defined with a center of the marker 3 as an origin by coordinate axes that orthogonally intersect each other. In the present embodiment, a marker coordinate system is used for arranging a virtual object (character 4) that is a manipulation object using the marker 3 (card 2), and the like.

For example, frontward, backward, leftward, and rightward directions are defined for the marker 3. In the example shown in FIG. 4, the forward direction of the marker 3 is a direction indicated by an arrow (marker 3). In this case, for example, an X axis (Xₘ) of a marker coordinate system is defined as an axis in the forward/backward direction of the marker 3. In addition, a Y axis (Yₘ) of a marker coordinate system is defined as an axis in the leftward/rightward direction of the marker 3. Furthermore, a Z axis (Zₘ) of a marker coordinate system is defined as an axis in a normal direction of a plane to which the marker 3 is attached. Moreover, in the present embodiment, the X-axis direction of a marker coordinate system coincides with the direction indicated by the marker 3 (the direction of the arrow). This is to describe a correspondence relationship between the marker 3 and a marker coordinate system in simple terms and does not mean that the present embodiment is limited to such a form. The X axis, Y axis, and Z axis of a marker coordinate system may be defined according to another reference.

Furthermore, as shown in FIG. 4, a marker coordinate system is defined for each marker 3. However, in the game system 100 according to the present embodiment, any one marker coordinate system can be shared among the respective markers 3. In addition, an origin of a marker coordinate system need not necessarily be a center of the marker 3. For example, an origin of a marker coordinate system may be any feature point of the marker 3.

The virtual space coordinate system (X_{g}, Y_{g}, Z_{g}) is a coordinate system related to arranging an virtual object (obstacle 5) other than a manipulation object using the marker 3 (card 2).

The camera coordinate system (X_{c}, Y_{c}, Z_{c}) is a coordinate system which has a focal position of the outer left imaging unit 23a or the outer right imaging unit 23b (hereinafter, simply referred to as the “outer imaging unit 23”) of the game device 1 as an origin and for which a Z axis (Z_{c}) is defined in an imaging direction of the outer imaging unit 23 and an X axis (X_{c}) and a Y axis (Y_{c}) are defined on a plane that orthogonally intersects the imaging direction.

The captured image plane coordinate system (Xₚ, Yₚ) is a coordinate system in which an X axis (Xₚ) and a Y axis (Yᵣ) are defined on a plane of a captured image that is captured by the outer imaging unit 23 of the game device 1.

A marker coordinate system can be transformed into a camera coordinate system by a rotation and a translation. In the present embodiment, such a rotation and a translation is performed by a homogeneous transformation matrix T_{cm}. However, the rotation and the translation for transforming a marker coordinate system into a camera coordinate system can be realized by a method other than matrix calculation. As will be described later, the homogeneous transformation matrix T_{cm} can be obtained from the marker 3.

Moreover, in FIG. 4, a homogeneous transformation matrix for transforming a marker coordinate system of the marker 3a into a camera coordinate system is expressed as “T_{cma}”. In addition, a homogeneous transformation matrix for transforming a marker coordinate system of the marker 3b into a camera coordinate system is expressed as “T_{cmb}”.

Furthermore, a virtual space coordinate system can be transformed into a camera coordinate system by a rotation and a translation in the same manner as a marker coordinate system. In the present embodiment, such a rotation and a translation is performed by a homogeneous transformation matrix T_{cg}. However, the rotation and the translation for transforming a virtual space coordinate system into a camera coordinate system can be realized by a method other than matrix calculation. The homogeneous transformation matrix T_{cg} is first provided as an initial setting. Subsequently, the homogeneous transformation matrix T_{cg} is appropriately updated based on a translation of the game device 1 as detected by the acceleration sensor 39 and a rotation of the game device 1 as detected by the angular velocity sensor 40.

Moreover, for example, a camera coordinate system can be transformed into a captured image plane coordinate system by a perspective transformation model.

In the present embodiment, an arrangement position of the character 4 shown in FIGS. 1A and 1B is expressed using a marker coordinate system. In addition, an arrangement position of the obstacle 5 is expressed using a virtual space coordinate system. The game device 1 respectively transforms a marker coordinate system and a virtual space coordinate system into a camera coordinate system using the homogeneous transformation matrix T_{cm} and the homogeneous transformation matrix T_{cg}. Furthermore, the game device 1 transforms a camera coordinate system into a captured image plane coordinate system using a perspective transformation model. Moreover, the game device 1 renders a virtual space image by generating an image of the character 4 and the obstacle 5 as expressed by captured image plane coordinate systems (an image of a virtual space as viewed from a virtual camera). In addition, the game device 1 displays a composite image in which the rendered virtual space image and a captured image that is captured by the outer imaging unit 23 are superimposed is displayed on the display 22. As described above, in the present embodiment, a camera coordinate system (and a marker coordinate system) that is used in a real space is also used in a virtual space. Therefore, since a coordinate system that is shared between a real space and a virtual space is used in the present embodiment, an alignment of a virtual object in a virtual space image and a real object in an image (captured image) of a real space can be readily performed.

Furthermore, in the present embodiment, a position variation of a virtual object such as the character 4 and the obstacle 5 is expressed by a relative position variation of the character 4 with respect to a virtual space. For example, let us assume that the character 4 is a virtual object whose position varies and that the obstacle 5 is a virtual object whose position does not vary. Let us also assume that the character 4 is a virtual object displayed on the card 2 (marker 3).

In this case, since the character 4 is a virtual object whose position varies, a parameter of the character 4 related to position variation has a value. A parameter related to position variation is, for example, a parameter related to a movement direction and a movement speed. In addition, for example, a movement direction is defined by a marker coordinate system.

Let us assume that, at this point, a coordinate value of an arrangement position of the character 4 is varied according to a parameter related to a position variation of the character 4. As a result, since the character 4 moves in a marker coordinate system, the character 4 is no longer displayed on the card 2 (marker 3). Therefore, in this case, the game device 1 realizes a position variation of the character 4 by varying a coordinate value of the obstacle 5 instead of varying a coordinate value of the arrangement position of the character 4. For example, first, in a marker coordinate system, the game device 1 prepares a vector whose direction is opposite to a movement direction of the character 4 and whose magnitude coincides with a speed of the character 4. Next, the game device 1 transforms the prepared vector into a vector that is expressed by a virtual space coordinate system using the homogeneous transformation matrix T_{cm} and the homogeneous transformation matrix T_{cg}. The game device 1 then varies a coordinate value of the obstacle 5 according to the transformed vector. Accordingly, a relative position of the character 4 varies in a relationship between the character 4 and the obstacle 5. In other words, a relative position variation of the character 4 with respect to a virtual space is realized.

However, a relative position variation of the character 4 is not limited to such a form. For example, let us assume that, in a virtual space coordinate system, a position of a origin of a camera coordinate system and a position of a origin of a marker coordinate system are determined in advance. In this case, for example, first, in a marker coordinate system, the game device 1 prepares a vector whose direction is a movement direction of the character 4 and whose magnitude coincides with a speed of the character 4. Next, the game device 1 transforms the prepared vector into a vector that is expressed by a virtual space coordinate system using the homogeneous transformation matrix T_{cm} and the homogeneous transformation matrix T_{cg}. The game device 1 then varies the position of the origin of the camera coordinate system and the position of the origin of the marker coordinate system in the virtual space coordinate system according to the transformed vector. Accordingly, a relative position of the character 4 varies in a relationship between the character 4 and the obstacle 5. In other words, a relative position variation of the character 4 with respect to a virtual space is realized. Moreover, in this case, the homogeneous transformation matrix T_{cg} must be appropriately updated based on a variation (translation) of the position of the origin of the camera coordinate system in the virtual space coordinate system.

As described above, a position variation of the character 4 according to the present embodiment may be realized by varying a coordinate value of an arrangement position of the character 4. In addition, a position variation of the character 4 according to the present embodiment may also be realized by varying a coordinate value of an arrangement position of a virtual object other than the character 4 (for example, the obstacle 5). The game system 100 according to the present embodiment controls the character 4 in such coordinate systems.

Moreover, a virtual space coordinate system may be replaced with a marker coordinate system associated with a card 2 used fixed in a real space among a plurality of marker coordinate systems. In this case, the homogeneous transformation matrix T_{cg} is replaced with the homogeneous transformation matrix T_{cm} associated with the marker coordinate system.

[Retained Information]

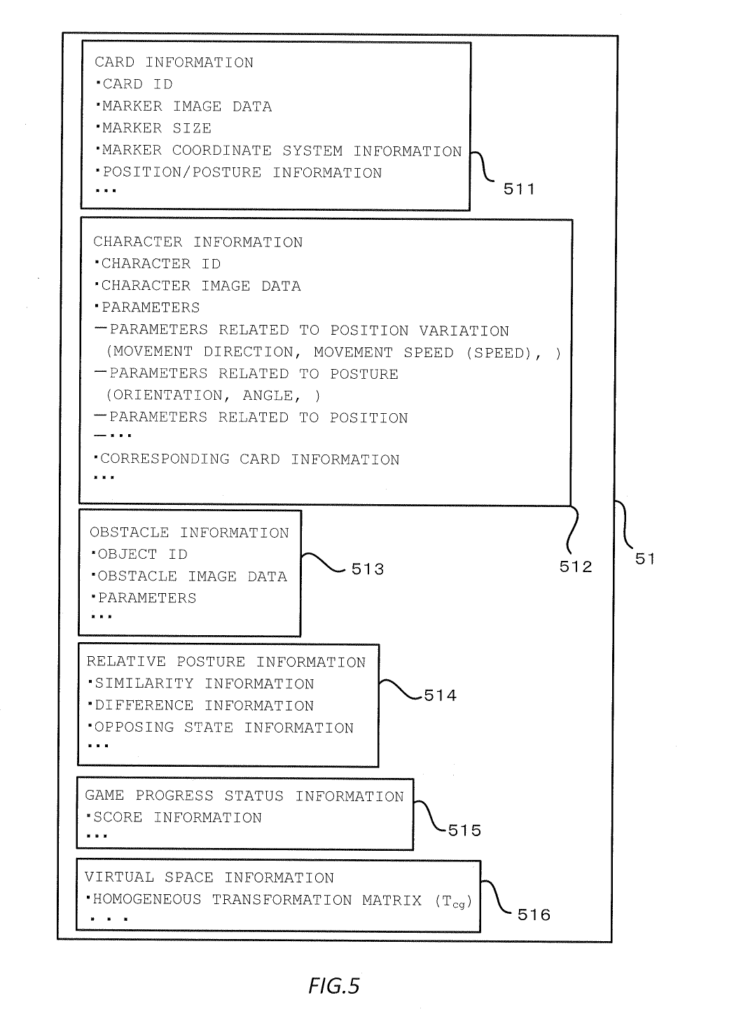

FIG. 5 illustrates information retained by the game device 1 according to the present embodiment. The game device 1 retains card information 511, character information 512, obstacle information 513, relative posture information 514, game progress status information 515, and virtual space information 516. The information is retained in a storage unit 51, which will be described later.

The card information 511 is information related to the card 2. The card information 511 exists for each card 2 that is used in the game system 100. For example, card information includes a card ID for identifying the card 2, marker image data, a marker size, marker coordinate system information, position/posture information, and the like. Marker image data is image data of the marker 3 attached to the card 2. A marker size is information indicating a size of the marker 3 attached to the card 2 such as longitudinal and horizontal lengths of the marker 3. In addition, marker coordinate system information is information indicating a relationship between the marker 3 and a marker coordinate system. The marker coordinate system information is, for example, coordinate values of a marker coordinate system at four vertices of a square of the marker 3.

The game device 1 is able to identify at least a posture of the marker 3 included in a captured image with respect to the outer imaging unit 23 based on the marker image data. For example, the game device 1 prepares patterns of the marker 3 in a plurality of posture states using the marker image data. The game device 1 then compares the marker 3 included in a captured image with the respective prepared patterns. As a result of the comparison, the game device 1 is able to identify a pattern most similar to the marker 3 included in the captured image. Subsequently, the game device 1 can identify a posture of the marker 3 included in the captured image from the identified pattern.

Moreover, besides a posture of the marker 3 included in the captured image, the game device 1 according to the present embodiment can also identify a position of the marker 3. Based on marker image data, a size of the marker 3, and marker coordinate system information, the game device 1 can identify position/posture information that indicates a position and a posture of the marker 3 (card 2) included in the captured image with respect to the outer imaging unit 23. For example, position/posture information is a homogeneous transformation matrix T_{cm} shown in FIG. 4 which is capable of transforming a marker coordinate system into a camera coordinate system. For example, the homogeneous transformation matrix T_{cm} can be expressed as a matrix including a 3×3 matrix R_{3×3} related to rotation and a 3×1 matrix t_{3×1} related to translation such as that presented in Expression 1.

$${T}_{c m} = ( \begin{matrix}{R}_{3 \times 3} & {t}_{3 \times 1} \\ 0 & 1\end{matrix} ) \qquad [ Expression 1 ]$$

The matrix R_{3×3} realizes a rotation for aligning respective directions of a coordinate axis of a marker coordinate system and a coordinate axis of a camera coordinate system. Therefore, using the matrix R_{3×3}, an orientation of a marker coordinate system with respect to the camera coordinate system can be identified. In other words, the matrix R_{3×3} is an example of posture information capable of identifying a posture of the card 2 with respect to the outer imaging unit 23. Using the matrix R_{3×3}, for example, a direction indicated by the marker 3 in a camera coordinate system (an orientation of an X axis of a marker coordinate system) can be identified. Moreover, in the present embodiment, a direction indicated by the marker 3 (an orientation of an X axis of a marker coordinate system) is assumed to be a direction that becomes a reference of a posture of the card 2. In other words, in the present embodiment, a direction indicated by the marker 3 in a camera coordinate system (a direction of an arrow) which can be identified from posture information is assumed to be a posture of the card 2 with respect to the outer imaging unit 23. Accordingly, the player is able to visually recognize a posture of the card 2 by the marker 3 (direction of the arrow). However, a posture of the card 2 with respect to the outer imaging unit 23 is not limited to such an example and may be expressed by another form.

The matrix t_{3×1} realizes a translation for aligning an origin of a marker coordinate system and an origin of a camera coordinate system. Therefore, using the matrix t_{3×1}, a position of a marker coordinate system in a camera coordinate system can be identified. In other words, the matrix t_{3×1} is an example of position information capable of identifying a position of the card 2 with respect to the outer imaging unit 23. Moreover, an origin of a marker coordinate system is a center of the marker 3. Therefore, using the matrix t_{3×1}, a coordinate value of the center of the marker 3 in a camera coordinate system can be identified.

The character information 512 is information related to the character 4. In other words, the character information 512 is information related to a virtual object that is a manipulation object according to the game system 100. For example, the character information 512 includes a character ID for identifying the character 4, character image data for displaying the character 4, values of parameters related to a state of the character 4, and corresponding marker information.

For example, as shown in FIG. 5, parameters indicating a state of the character 4 include a parameter related to a position variation, a parameter related to a posture, and a parameter related to a position.

A parameter related to a position variation is, for example, a parameter related to a movement direction, a movement speed (speed), or the like. A value of a parameter related to a movement direction determines a direction in which the character 4 moves in a virtual space. In addition, a value of a parameter related to a movement speed determines a variation of a position of the character 4 in a virtual space. In the present embodiment, a marker coordinate system is used as a coordinate system for defining values set to these parameters. However, another coordinate system (for example, a virtual space coordinate system) may be used as a coordinate system for defining the values set to these parameters. In addition, a value of a parameter related to a movement direction and a value of a parameter related to a movement speed may be expressed by a single vector value.

Furthermore, a parameter related to a posture is, for example, a parameter related to an orientation, an angle, or the like of the character 4. For example, let us assume that, as an initial setting, the character 4 is arranged orthogonally facing an X-axis direction on an XY plane of a coordinate system (marker coordinate system) which determines a position of the character 4. In this case, for example, an orientation of the character 4 is expressed as an angle between a front direction of the character 4 and the X axis of the coordinate system on the XY plane. In addition, for example, an angle of the character 4 is expressed as an angle between a vertical direction of the character 4 and a Z axis of the coordinate system. The parameters related to an orientation and an angle may be set for each body part (for example, a joint) of the character 4. In this case, for example, an orientation of a body part of the character 4 is determined by an angle of a difference from an orientation provided as an initial setting in a horizontal direction of the body part. A twist of a body part of the character 4 is expressed by an orientation of the body part of the character 4. Furthermore, for example, an angle of a body part of the character 4 is determined by an angle of a difference from an angle provided as an initial setting in a vertical direction of the body part. A bend of a body part of the character 4 is expressed by an angle of the body part of the character 4. In the present embodiment, a marker coordinate system is used as a coordinate system for defining a value set to a parameter related to an orientation. However, another coordinate system may be used as a coordinate system for defining a value set to a parameter related to an orientation.

In addition, a parameter related to a position is, for example, a parameter related to an arrangement position or the like of the character 4 in a marker coordinate system. In the present embodiment, an arrangement position is provided as a coordinate value. Moreover, an arrangement position of the character 4 may be set in correspondence with a body part of the character 4. For example, arrangement positions of a left foot and a right foot of the character 4 may be set separately. Furthermore, since marker coordinate systems related to arrangement positions of the character 4 can be transformed into a common coordinate system using the homogeneous transformation matrix T_{cm}, marker coordinate systems may differ among body parts of the character 4. For example, a marker coordinate system of the marker 3a (card 2a) may be used as a coordinate system for an arrangement position of a left foot of the character 4 and a marker coordinate system of the marker 3b (card 2b) may be used as a coordinate system for an arrangement position of a right foot of the character 4. Such a correspondence relationship between the character 4 and a plurality of cards 2 is indicated by corresponding card information.

The obstacle information 513 is information related to the obstacle 5. In other words, the obstacle information 513 is information related to a virtual object other than a manipulation object according to the game system 100. For example, the obstacle information 513 includes an object ID for identifying the obstacle 5, obstacle image data for displaying the obstacle 5, and parameters related to a state of the obstacle 5. Since parameters related to a state of the obstacle 5 are similar to the parameters related to a state of the character 4, a description thereof will be omitted. Moreover, as described earlier, an arrangement position of the obstacle 5 according to the present embodiment is expressed using a virtual space coordinate system.

The relative posture information 514 is information indicating a relative posture relationship among a plurality of cards 2 which is acquired from posture information or position/posture information included in the card information 511 of the plurality of cards 2. As described earlier, for example, the posture information included in the card information 511 is the matrix R_{3×3}. In addition, for example, the position/posture information is the homogeneous transformation matrix T_{cm}. The game device 1 acquires the relative posture information 514 using posture information or position/posture information included in the card information 511 of a plurality of cards 2. Moreover, for example, the relative posture information 514 includes similarity information, difference information, and opposing state information.

Similarity information indicates a similarity of posture between two cards 2 among the plurality of cards 2. The game device 1 obtains similarity information using posture information included in the card information 511 of the two compared cards 2. The more similar the postures of the two compared cards 2, the higher the similarity indicated by the similarity information. For example, the smaller a difference angle between directions indicated by markers 3 of the two compared cards 2, the higher the similarity indicated by the similarity information. A specific example of a similarity is presented by Expression 2 below. Moreover, it is assumed that a difference angle ranges from 0 degrees to 180 degrees.

$$Similarity = 100 \times \frac{180 - Difference angle}{180} \qquad [ Expression 2 ]$$

When there are three or more cards 2, the game device 1 is able to acquire a plurality of similarities between postures. In this case, for example, the game device 1 may select a similarity to be used in similarity information. In addition, the game device 1 may use a sum of the acquired plurality of similarities in similarity information.

Difference information indicates a difference in posture between two cards 2 among a plurality of cards 2. For example, difference information indicates an angle of a difference between orientations indicated by the markers 3 of the two cards 2. The game device 1 obtains difference information using posture information included in the card information 511 of the two compared cards 2. Since cases in which three or more cards 2 exist are similar to those of similarity information, a description thereof will be omitted.

Opposing state information indicates an opposing state that is identified from positions and postures of at least two cards 2 among the plurality of cards 2. The game device 1 obtains opposing state information using position/posture information included in the card information 511 of the at least two cards 2. Opposing state information according to the present embodiment is expressed by a 2-bit flag indicating that a current state is any of a state in which the postures of the plurality of cards 2 are arranged face to face, a state in which postures of a plurality of cards 2 are arranged back to back, and a state that is neither of the two states.

In the present embodiment, as described earlier, a posture of the card 2 is illustrated by an orientation indicated by the marker 3 (an orientation of an arrow). Hereinafter, a direction in which a posture of the card 2 is oriented will also be referred to as an “orientation of the card 2”. In the present embodiment, a state in which postures of cards 2 are arranged face to face refers to a state in which arrows of markers 3 are arranged face to face. In addition, a state in which the postures of cards 2 are arranged back to back refers to a state in which arrows of the markers 3 are arranged back to back.

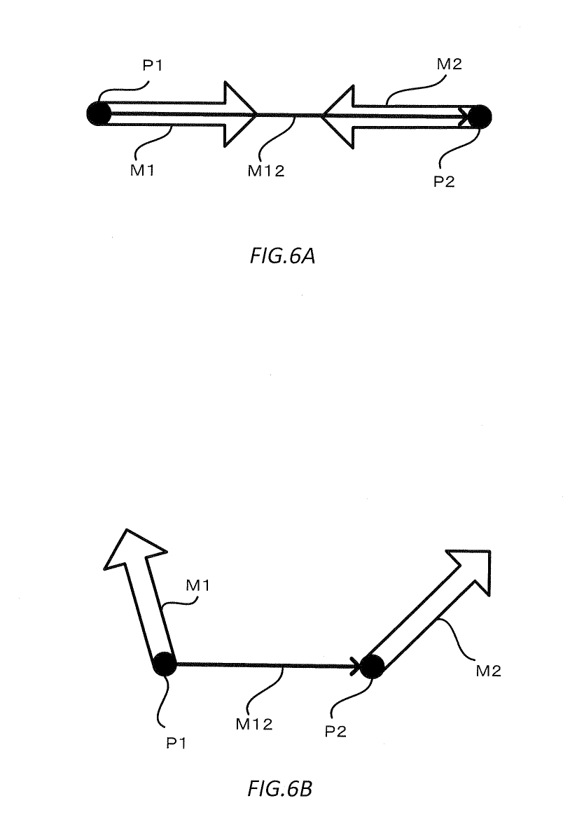

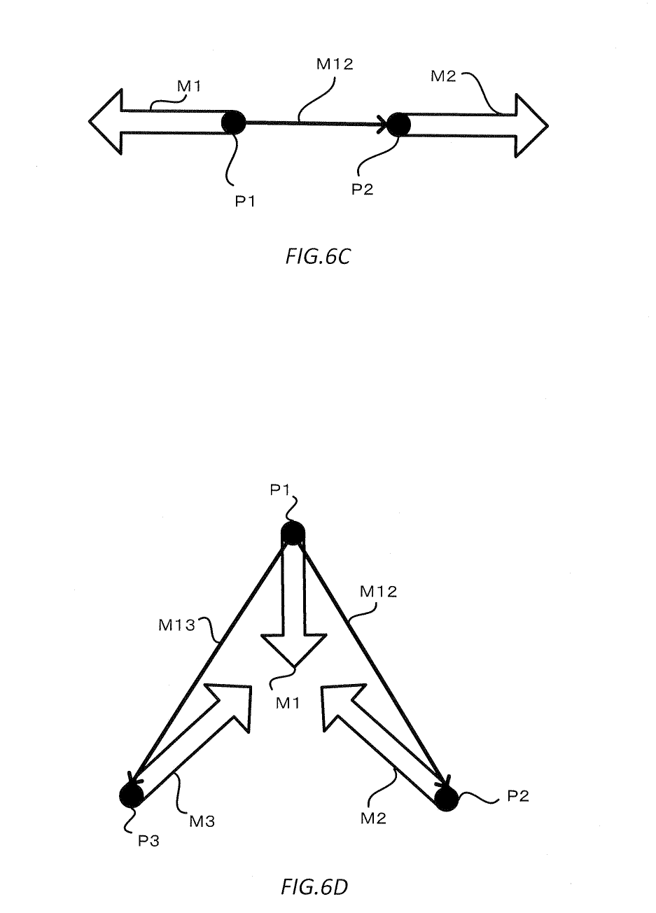

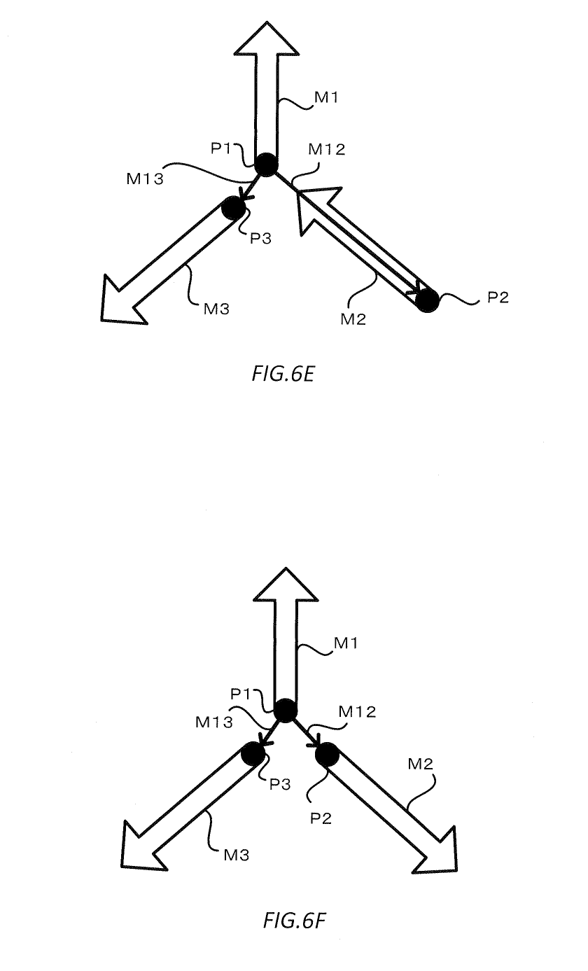

Alternatively, for example, opposing state information may be expressed by a 1-bit flag indicating whether or not the postures of a plurality of cards 2 are arranged face to face or whether or not the postures of a plurality of cards 2 are arranged back to back. In addition, for each of the plurality of cards 2, a displacement (angle) from a state in which the postures of the cards 2 are arranged face to face or arranged back to back is conceivable. The displacement (angle) can be obtained for each card 2 and therefore exists in a same number as the number of cards 2. For example, opposing state information may be expressed as a sum of the displacements (angles) that exist in plurality. Hereinafter, opposing state information will be described with reference to FIGS. 6A to 6F.

FIGS. 6A to 6C are diagrams for describing an opposing state as identified from positions and postures of two cards 2. A direction of an arrow M1 indicates an orientation of a first card 2 among the two cards 2. In addition, a direction of an arrow M2 indicates an orientation of a second card 2 among the two cards 2. An origin P1 of the arrow M1 indicates a position in a camera coordinate system of the first card 2. In addition, an origin P2 of the arrow M2 indicates a position in a camera coordinate system of the second card 2. Furthermore, an arrow M12 indicates a vector with P1 as an initial point and P2 as a terminal point. In other words, M12 denotes a difference vector (relative position vector) obtained by subtracting a position vector of the first card 2 from a position vector of the second card 2. These vectors can be identified from position information and posture information included in position/posture information of the card information 511 of each card 2.

Note that, in the present embodiment, a direction used as a reference of a posture of the card 2 (an orientation of the card 2) is a direction of an X axis of a marker coordinate system related to the card 2. Therefore, in the present embodiment, an orientation of each card 2 is expressed by a unit vector of an X axis of each marker coordinate system. However, an orientation of the card 2 may be expressed by other forms. In addition, a unit vector for expressing an orientation of the card 2 may be a vector with a settable and modifiable length. An orientation of the card 2 expressed by a unit vector of the X axis of a marker coordinate system can be expressed by a vector in a camera coordinate system using the homogeneous transformation matrix T_{cm}. In other words, M1 and M2 can be respectively expressed by vectors in a camera coordinate system. Hereinafter, M1 and M2 will be described as being vectors indicating orientations of their respective cards 2.

Furthermore, a position of each card 2 in a camera coordinate system can be identified by position information included in position/posture information of the card information 511 of each card 2. Therefore, in a similar manner as M1 and M2, M12 can also be expressed by a vector in a camera coordinate system. As shown, in the present embodiment, M1, M2, and M12 can be expressed by a common coordinate system. Furthermore, for example, an opposing state of the postures of the first card 2 and the second card 2 can be determined using M1, M2, and M12 which can be expressed by the common coordinate system.

The terms “first card 2” and “second card 2” are used in order distinguish the two cards 2 from each other. For example, the first card 2 is the card 2a shown in FIGS. 1A and 1B. In addition, for example, the second card 2 is the card 2b shown in FIGS. 1A and 1B. The correspondence relationships may be interchanged.

In this case, a relationship described by Expression 3 below exists between two vectors V and W.

$$cos θ = \frac{V \cdot W}{\vert V \vert \vert W \vert} \qquad [ Expression 3 ]$$

“V·W” denotes an inner product of the two vectors V and W. “θ” denotes a magnitude of an angle formed by the two vectors V and W. “|V|” denotes a length of the vector V. “|W|” denotes a length of the vector W.

As described earlier, M1, M2, and M12 can be expressed by vectors in a camera coordinate system. Therefore, the game device 1 is able to calculate an inner product of M1 and M2 and an inner product of M1 and M12. In addition, using Expression 3, the game device 1 is able to identify a magnitude of an angle formed by M1 and M2 and a magnitude of an angle formed by M1 and M12. For example, the game device 1 can determine an opposing state of the postures of the first card 2 and the second card 2 from a magnitude of an angle formed by M1 and M2 and a magnitude of an angle formed by M1 and M12. It is needless to say that, using Expression 3, the game device 1 may use cosines (cos θ) of angles formed by the respective vectors instead of the magnitude (θ) of angles formed by the respective vectors in order to identify an opposing state. In the present embodiment, for the sake of simplicity, an opposing state of the postures of the first card 2 and the second card 2 will be described using the magnitude (θ) of angles formed by the respective vectors. Moreover, it is assumed that the magnitude (θ) of angles formed by the respective vectors ranges from 0 degrees to 180 degrees.

FIG. 6A illustrates a state in which two cards 2 are arranged face to face. In addition, FIG. 6C illustrates a state in which two cards 2 are arranged back to back. As shown, when M1 and M2 are oriented in directions arranged back to back, magnitudes of angles formed by M1 and M2 are both 180 degrees. In contrast, when the two cards 2 are arranged face to face, a magnitude of an angle formed by M1 and M12 is 0 degrees. On the other hand, when the two cards 2 are arranged back to back, a magnitude of an angle formed by M1 and M12 is 180 degrees. In other words, the game device 1 can identify whether or not the two cards 2 are arranged face to face or arranged back to back based on a magnitude of an angle formed by M1 and M2. In addition, the game device 1 can identify whether the two cards 2 are arranged face to face or arranged back to back based on a magnitude of an angle formed by M1 and M12.

For example, when it is judged that a magnitude of an angle formed by M1 and M2 exceeds a settable and modifiable first threshold, the two cards 2 can be determined as arranged face to face or being arranged back to back. On the other hand, when it is judged that the magnitude of the angle formed by M1 and M2 is equal to or smaller than the settable and modifiable first threshold, the two cards 2 can be determined as being in a state in which the two cards 2 are neither arranged face to face nor arranged back to back. In addition, if it is judged that a magnitude of an angle formed by M1 and M12 exceeds a settable and modifiable second threshold when the two cards 2 are judged as being arranged face to face or being arranged back to back, the two cards 2 can be determined as being arranged back to back. Furthermore, if it is judged that a magnitude of an angle formed by M1 and M12 is equal to or smaller than the settable and modifiable second threshold when the two cards 2 are judged as being arranged face to face or being arranged back to back, the two cards 2 can be determined as being arranged face to face. Therefore, the game device 1 can judge whether the two cards 2 are arranged face to face or arranged back to back by comparing an angle formed by M1 and M2 with a first threshold. In addition, when it is judged that the two cards 2 are being arranged face to face or being arranged back to back, the game device 1 can judge whether the two cards 2 are arranged face to face or the two cards 2 are arranged back to back by comparing an angle formed by M1 and M12 with a second threshold. Consequently, by the first threshold and the second threshold, the state illustrated in FIG. 6B is identified as being any of a state in which postures of the first card 2 and the second card 2 are arranged face to face, a state in which postures of the first card 2 and the second card 2 are arranged back to back, and a state that is neither of the two states.

Moreover, a magnitude of an angle formed by M1 and M2 is used to judge whether or not the two cards 2 are arranged face to face or arranged back to back. In the present embodiment, M1 and M2 are unit vectors indicating respective orientations of the two cards 2. As shown, lengths of M1 and M2 are provided by settings. Therefore, a value of an inner product of M1 and M2 forms a one-to-one relationship with a magnitude of an angle formed by M1 and M2. In consideration of this relationship, the game device 1 may use a value of an inner product of M1 and M2 in place of a magnitude of an angle formed by M1 and M2 in order to judge whether or not the two cards 2 are arranged face to face or arranged back to back.

In addition, a magnitude of an angle formed by M1 and M12 is used to judge whether the two cards 2 are arranged face to face or the two cards 2 are arranged back to back. In the present embodiment, M12 is a relative position vector indicating a relative positional relationship between the first card 2 and the second card 2. Therefore, a length of M12 is variable depending on positions of the first card 2 and the second card 2. Accordingly, a value of an inner product of M1 and M12 does not form a one-to-one relationship with a magnitude of an angle formed by M1 and M12. However, a value obtained by dividing the value of the inner product of M1 and M12 by a length of M12 forms a one-to-one relationship with a magnitude of an angle formed by M1 and M12. In consideration of this relationship, the game device 1 may use a value obtained by dividing the value of the inner product of M1 and M12 by the length of M12 in place of a magnitude of an angle formed by M1 and M12 in order to judge whether the two cards 2 are arranged face to face or the two cards 2 are arranged back to back.

Furthermore, let us assume that the game device 1 uses 90 degrees as the second threshold for judging whether the two cards 2 are arranged face to face or the two cards 2 are arranged back to back. In this case, when an angle formed by M1 and M12 exceeds 90 degrees, a value of an inner product of M1 and M12 takes a negative value. In addition, when an angle formed by M1 and M12 is equal to or smaller than 90 degrees, a value of an inner product of M1 and M12 takes a positive value (including 0). Therefore, the game device 1 is able to identify whether or not an angle formed by M1 and M12 exceeds the second threshold (90 degrees) by judging whether the value of the inner product of M1 and M12 is a negative value or a positive value. Accordingly, in such a case, the game device 1 may use a value of an inner product of M1 and M12 in place of a magnitude of an angle formed by M1 and M12 in order to judge whether the two cards 2 are arranged face to face or the two cards 2 are arranged back to back.

FIGS. 6D to 6F are diagrams for describing opposing states as identified from positions and postures of three cards. States of three cards 2 are respectively illustrated. An arrow M3 indicates a posture of a third card 2 among the three cards 2. An origin P3 of the arrow M3 indicates a position in a camera coordinate system of the third card 2. An arrow M13 indicates a vector with P1 as an initial point and P3 as a terminal point. In other words, M13 denotes a difference vector (relative position vector) obtained by subtracting a position vector of the first card 2 from a position vector of the third card 2. As shown, even if there are three or more cards 2, opposing state information can be explained in similar manner as a case of two cards 2. In other words, the game device 1 can identify an opposing state of the first card 2 and the second card 2 from a magnitude of an angle formed by M1 and M2 and a magnitude of an angle formed by M1 and M12. In addition, the game device 1 can identify an opposing state of the first card 2 and the third card 2 from a magnitude of an angle formed by M1 and M3 and a magnitude of an angle formed by M1 and M13. Accordingly, for example, a state shown in FIG. 6E may be identified as being a state in which only the first card 2 and the third card 2 are arranged back to back among the three cards 2. As shown, when there are three or more cards 2, opposing state information may indicate respective opposing states of two cards 2 among the cards 2.

Furthermore, when there are three or more cards 2, opposing states of all cards 2 can be determined by using respective opposing states of two cards 2 among the cards 2. For example, a state shown in FIG. 6D may be specified as being a state in which the three cards 2 are arranged face to face. In addition, a state shown in FIG. 6F may be specified as being a state in which the three cards 2 are arranged back to back. These states are identified from an opposing state of the first card 2 and the second card 2 and an opposing state of the first card 2 and the third card 2. In other words, the game device 1 can identify the opposing states of all cards 2 from respective opposing states of two cards 2 among the cards 2. As shown, when there are three or more cards 2, opposing state information may indicate opposing states of all of the cards 2.

The game device 1 according to the present embodiment controls the character 4 (virtual object) using such relative posture information 514. However, control of a virtual object according to the present embodiment is not limited to such a form. An example in which the relative posture information 514 is not used will be presented in a modification which will be described later.

The game progress status information 515 is information including a game progress status. For example, the game progress status information 515 includes score information of a ski game.

The virtual space information 516 is information related to a virtual space coordinate system. For example, the virtual space information 516 includes the homogeneous transformation matrix T_{cg}.

[Function Blocks]

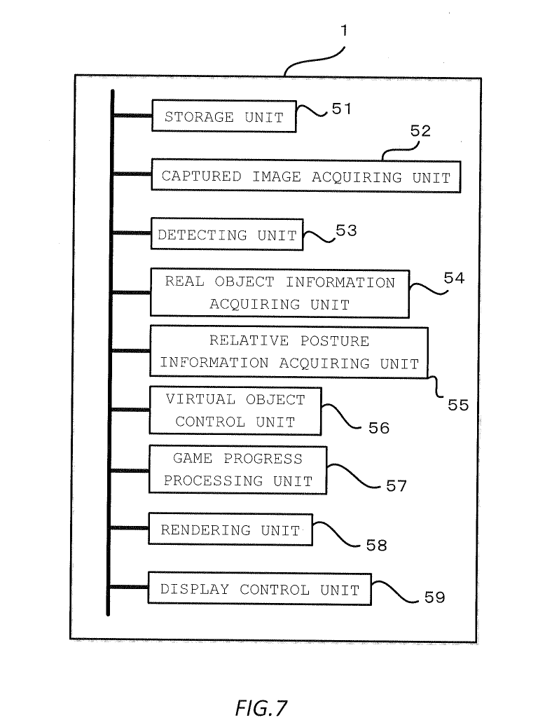

FIG. 7 illustrates function blocks of the game device 1 according to the present embodiment. The respective function blocks shown in FIG. 7 represent parts of functions that are realized by the information processing unit 31 (the CPU 311 and the GPU 312) by, for example, reading and executing a game program stored in the external memory 45.

Due to execution of the game program, the game device 1 operates as a storage unit 51, a captured image acquiring unit 52, a detecting unit 53, a real object information acquiring unit 54, a relative posture information acquiring unit 55, a virtual object control unit 56, a game progress processing unit 57, a rendering unit 58, and a display control unit 59.

The storage unit 51 stores card information 511, character information 512, obstacle information 513, relative posture information 514, game progress status information 515, and virtual space information 516.

The captured image acquiring unit 52 acquires a captured image that is captured by the outer imaging unit 23. More specifically, the captured image acquiring unit 52 instructs the outer imaging unit 23 to perform an image capturing operation. The captured image acquiring unit 52 then acquires a captured image that is captured by the outer imaging unit 23 in accordance with the instruction. For example, the captured image acquiring unit 52 repetitively instructs the outer imaging unit 23 to perform an image capturing operation. Accordingly, the captured image acquiring unit 52 repetitively acquires captured images. For example, let us assume that game processing according to the present embodiment is executed in units of frames divided at 60 frames/second. In this case, the captured image acquiring unit 52 repetitively instructs the outer imaging unit 23 to perform an image capturing operation and acquires captured images every 1/60 second.

The detecting unit 53 detects a marker 3 corresponding to a marker image included in the card information 511 from a captured image. Such a detection of a marker 3 is performed using, for example, an image recognition engine.

Based on the detected marker 3, the real object information acquiring unit 54 acquires position/posture information (for example, a homogeneous transformation matrix T_{cm}) indicating respective positions and postures of cards 2 with respect to the outer imaging unit 23. For example, such position/posture information can be acquired using a software library such as ARToolKit. Acquired position/posture information is respectively stored in the storage unit 51 as a part of the card information 511.

Based on a plurality of pieces of card information 511 acquired by the real object information acquiring unit 54, the relative posture information acquiring unit 55 acquires relative posture information 514 that indicates a relative posture relationship among a plurality of cards 2. The acquired relative posture information 514 is stored in the storage unit 51. Moreover, for example, the relative posture information 514 includes similarity information, difference information, and opposing state information.

The virtual object control unit 56 controls the character 4 based on the plurality of pieces of card information 511 acquired by the real object information acquiring unit 54. In addition, the virtual object control unit 56 controls the character 4 based on the relative posture information acquired by the relative posture information acquiring unit 55. For example, when controlling the character 4, the virtual object control unit 56 changes a value of a parameter related to a state of the character 4. At this point, the parameter whose value is changed by the virtual object control unit 56 may be a parameter related to a position variation of the character 4. In addition, when controlling a position variation of the character 4, the virtual object control unit 56 may vary a relative position of the character 4 with respect to a virtual space based on a value of a parameter related to a position variation of the character 4.

The game progress processing unit 57 manages game progress of the ski game according to the present embodiment by referencing and updating the game progress status information 515. For example, the game progress processing unit 57 manages a score obtained by the player by manipulating the character 4 and manages a time course in a virtual space in accordance with a time course in a real space that is acquired by the RTC 38.

The rendering unit 58 sets a position and a posture of a virtual camera arranged in a virtual space and arranges the character 4 whose position and posture are determined by the plurality of pieces of card information 511 in the virtual space. In addition, the rendering unit 58 renders a virtual space image by generating an image of the virtual space as viewed from the virtual camera.

The display control unit 59 generates a composite image in which the virtual space image is superimposed on a captured image that is captured by the outer imaging unit 23. The display control unit 59 causes the generated composite image to be displayed on the upper LCD 22.

Moreover, hereinafter, when describing processes performed by the respective aforementioned functions realized by the information processing unit 31, the respective function blocks will be described as processing entities in place of the information processing unit 31.

### §2 Operation Example

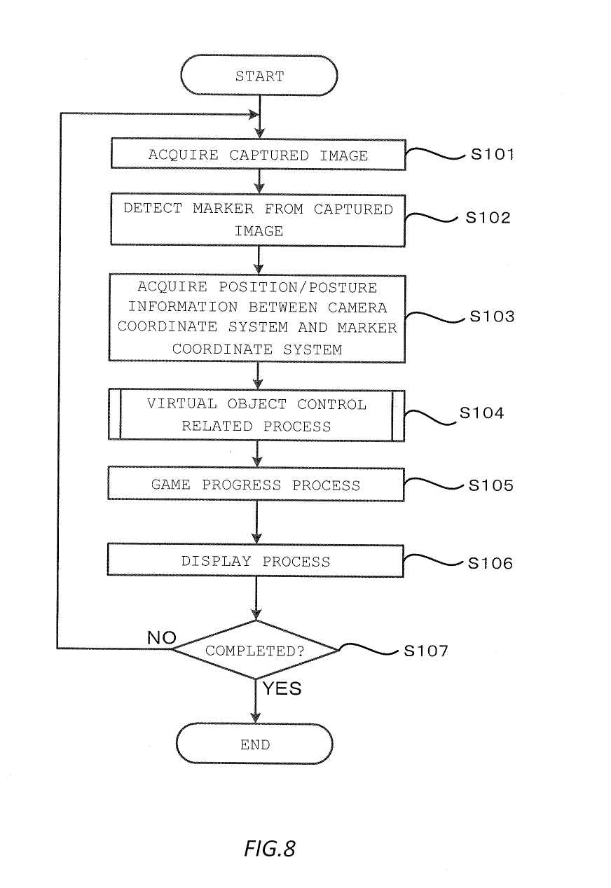

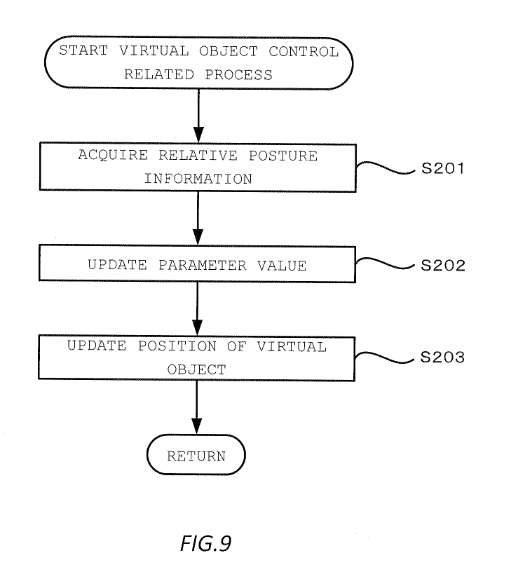

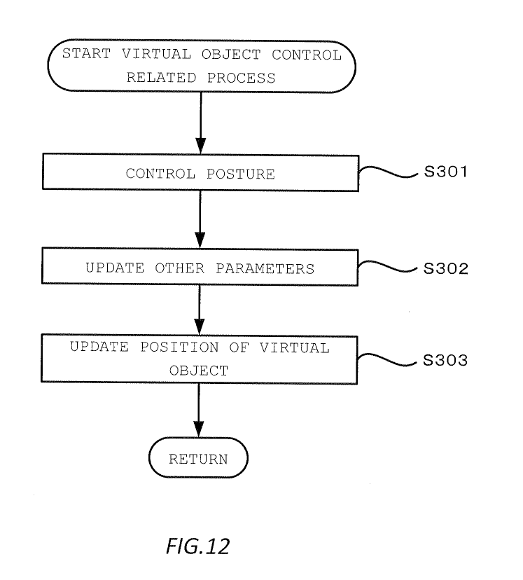

Next, a flow of game processing according to the present embodiment will be described with reference to FIG. 8. FIG. 8 is a flow chart showing a flow of game processing according to the present embodiment. In FIG. 8, a step will be abbreviated as “S” (this also applies to FIGS. 9 and 12, which will be described later).

In step 101 and step 102, a captured image is acquired and a marker 3 is detected from the captured image. The captured image acquiring unit 52 acquires a captured image that is captured by the outer imaging unit 23 (step 101). Once a captured image is acquired, from the captured image, the detecting unit 53 detects a marker 3 corresponding to a marker represented by marker image data included in the card information 511 (step 102). With the exception of a case in which the marker 3 is arranged so as to orthogonally intersect a Z axis of a camera coordinate system (in other words, arranged parallel to a captured image plane), an image of the marker 3 is captured in a state in which the marker 3 is distorted in the captured image. Even in this case, the detection of the marker 3 can be performed using a general image recognition engine. Subsequently, processing proceeds to step 103.

In step 103, position/posture information is acquired for each marker 3. For each marker 3 detected in step 102, the real object information acquiring unit 54 acquires position/posture information indicating a position and a posture of a card 2, to which the marker 3 is attached, with respect to the outer imaging unit 23. For example, position/posture information is a homogeneous transformation matrix T_{cm} capable of transforming a marker coordinate system into a camera coordinate system. In addition, the real object information acquiring unit 54 causes the storage unit 51 to respectively store the acquired pieces of position/posture information as a part of the card information 511. Subsequently, processing proceeds to step 104.

In step 104, a virtual object control related process is executed, and processing then proceeds to a next step 105. FIG. 9 is a flowchart that illustrates a procedure of the virtual object control related process. Hereinafter, the virtual object control related process will be described with reference to FIG. 9.

In step 201, relative posture information is acquired. The relative posture information acquiring unit 55 acquires relative posture information 514 based on the plurality of pieces of card information 511 (position/posture information) stored in the storage unit 51. The relative posture information acquiring unit 55 then causes the storage unit 51 to store the acquired relative posture information 514. Moreover, the relative posture information 514 according to the present embodiment includes similarity information, difference information, and opposing state information which have been described earlier. The relative posture information acquiring unit 55 obtains these pieces of information from the plurality of pieces of card information 511 (position/posture information) stored in the storage unit 51. The relative posture information acquiring unit 55 then acquires relative posture information 514 including the obtained information.

In step 202, values of parameters are updated. The virtual object control unit 56 updates values of the respective parameters using the plurality of pieces of card information 511 (position/posture information) or the relative posture information 514. Hereinafter, updating of values of parameters by the virtual object control unit 56 will be exemplified. As described earlier, the card 2a corresponds to a left foot of the character 4. In addition, the card 2b corresponds to a right foot of the character 4.

The virtual object control unit 56 updates a value of a parameter related to a movement direction of the character 4 based on an orientation of the card 2. In this case, it is assumed that the value of the parameter related to the movement direction of the character 4 is defined by a marker coordinate system of the marker 3a. At this point, the virtual object control unit 56 obtains a posture (orientation of an X_{mb} axis) of the card 2b in a marker coordinate system (Xₘₐ, Yₘₐ, Zₘₐ) based on the position/posture information (T_{cma} and T_{cmb}) included in the respective pieces of card information 511. Specifically, the posture of the card 2b (orientation of an X_{mb} axis) in a marker coordinate system (Xₘₐ, Yₘₐ, Zₘₐ) is obtained by multiplying an X_{mb} unit vector in a marker coordinate system (X_{mb}, Y_{mb}, Z_{mb}) by T_{cmb} and T⁻¹_{cma} (inverse matrix of T_{cma}). Subsequently, the virtual object control unit 56 updates the value of the parameter related to the movement direction of the character 4 included in the character information 512 based on orientations of the card 2a and the card 2b expressed by the marker coordinate system (Xₘₐ, Yₘₐ, Zₘₐ). For example, the virtual object control unit 56 updates the value of the parameter related to the movement direction of the character 4 to a value indicating an intermediate direction of posture directions of the card 2a and the card 2b. Moreover, homogeneous transformation matrixes T_{cma} and T_{cmb} can be replaced with a matrix R_{3×3} (posture information) related to each rotation.

At this point, the virtual object control unit 56 may also update a value of a parameter related to an orientation of the character 4 included in the character information 512 to a similar value. The parameter related to the orientation of the character 4 determines a forward direction of the character 4. Accordingly, a movement direction of the character 4 takes an intermediate direction of directions indicated by the two cards 2.

In addition, the virtual object control unit 56 updates a value of a parameter related to a movement speed (speed) of the character 4 based on similarity information included in the relative posture information 514. For example, the higher a similarity between postures of the card 2a and the card 2b indicated by the similarity information included in the relative posture information 514, the greater the value to which the virtual object control unit 56 updates the value of the parameter related to a movement speed of the character 4. When updating movement speed, the virtual object control unit 56 may increase or decrease the movement speed using an acceleration determined by similarity. Furthermore, when updating movement speed, the virtual object control unit 56 may uniformly determine movement speed based on uniformity. Accordingly, the closer a direction indicated by the two cards is to a schuss-like state, the higher the movement speed of the character 4.

In addition, the virtual object control unit 56 updates a value of a parameter related to angles of a waist and knees of the character 4 based on difference information included in the relative posture information 514. Specifically, the greater a difference between postures of the card 2a and the card 2b indicated by the difference information included in the relative posture information 514, the greater the value to which the virtual object control unit 56 updates the value of the parameter related to angles of a waist and knees of the character 4 (up to a maximum value of 180 degrees). Accordingly, the greater the separation between directions indicated by the two cards, the more straight the waist and knees of the character 4.

Furthermore, the virtual object control unit 56 controls an action of the character 4 based on opposing state information included in the relative posture information 514. When the opposing state information indicates that the postures of the card 2a and the card 2b are in an opposing state, the virtual object control unit 56 causes the character 4 to execute a falling action in a movement direction. On the other hand, when the opposing state information indicates that the postures of the card 2a and the card 2b are arranged back to back, the virtual object control unit 56 causes the character 4 to execute a rearward falling action with respect to the movement direction.

Moreover, the virtual object control unit 56 updates the homogeneous transformation matrix T_{cg} included in the virtual space information 516 based on a translation of the game device 1 detected by the acceleration sensor 39 and a rotation of the game device 1 detected by the angular velocity sensor 40.

In step 203, arrangement positions of virtual objects such as the character 4 and the obstacle 5 are updated. In the present embodiment, an arrangement position of the character 4 is expressed by a marker coordinate system. In addition, an arrangement position of the obstacle 5 is expressed by a virtual space coordinate system. For example, as described earlier, the virtual object control unit 56 updates a coordinate value of the obstacle 5 using position/posture information (homogeneous transformation matrix T_{cm}) included in the card information 511, values of parameters related to position variation included in the character information 512, and the homogeneous transformation matrix T_{cg} included in virtual space information. Subsequently, the virtual object control related process is concluded and processing proceeds to a next step 105.

Returning now to FIG. 8, in step 105, a game progress process is executed. For example, the game progress processing unit 57 references the character information 512 and the obstacle information 513 in the storage unit 51 to judge whether or not a predetermined event or the like has occurred. In the ski game according to the present embodiment, examples of a predetermined event include the character 4 colliding with the obstacle 5 in a virtual space. When such an even occurs, for example, the game progress processing unit 57 updates score information included in the game progress status information 515 in the storage unit 51. In addition, for example, the game progress processing unit 57 updates in-gate time in accordance with a time course in a real space. Once the game progress process is concluded, the processing proceeds to step 106.

In step 106, a display process is executed. The rendering unit 58 renders a virtual object from a perspective of a virtual camera arranged at a same position as the outer imaging unit 23. In other words, the rendering unit 58 uses a camera coordinate system to render a virtual object. In the present embodiment, virtual objects include the character 4 indicated by the character information 512 and the obstacle 5 indicated by the obstacle information 513. The display control unit 59 then synthesizes the rendered image of the virtual object (virtual space image) onto the captured image, and outputs the composite image to the upper LCD 22 and causes the composite image to be displayed. Subsequently, processing proceeds to a next step 107.

In step 107, the game progress processing unit 57 determines whether or not the game is over. For example, the game progress processing unit 57 determines whether the game is over based on an occurrence of an event such as a lapse of a predetermined period of time. When the game progress processing unit 57 determines that the game is over (YES in step 107), the game processing according to the present embodiment is concluded. On the other hand, when the game progress processing unit 57 determines that the game is not over (NO in step 107), the game processing according to the present embodiment returns to step 101 and is repeated.

According to the present embodiment, a character 4 is controlled by postures of a plurality of cards 2 to which markers 3 are attached. For example, a movement direction, a movement speed, and the like of the character 4 are controlled by postures of two cards 2. As shown, according to the present embodiment, when controlling the character 4 using the marker 3, control of the character 4 can be performed in wider variations.

### §3 Modification

Next, as a modification, an example will be presented in which the game device 1 controls a character 4 (virtual object) without using relative posture information 514. Moreover, the present embodiment and the modification share the same configuration of the game device 1 shown in FIGS. 2 and 3 and the same coordinate systems shown in FIG. 4 which are used by the game system 100.

Based on posture information (card information) of a plurality of cards 2, a game system 100 according to the present modification controls a posture indicated by a plurality of parameters which is related to a posture of a character 4 and which is respectively in a correspondence relationship with each piece of posture information of the plurality of cards 2.

In addition, based on the posture controlled in this manner, the game system 100 according to the present modification changes values of parameters related to other states besides the plurality of parameters related to the posture.

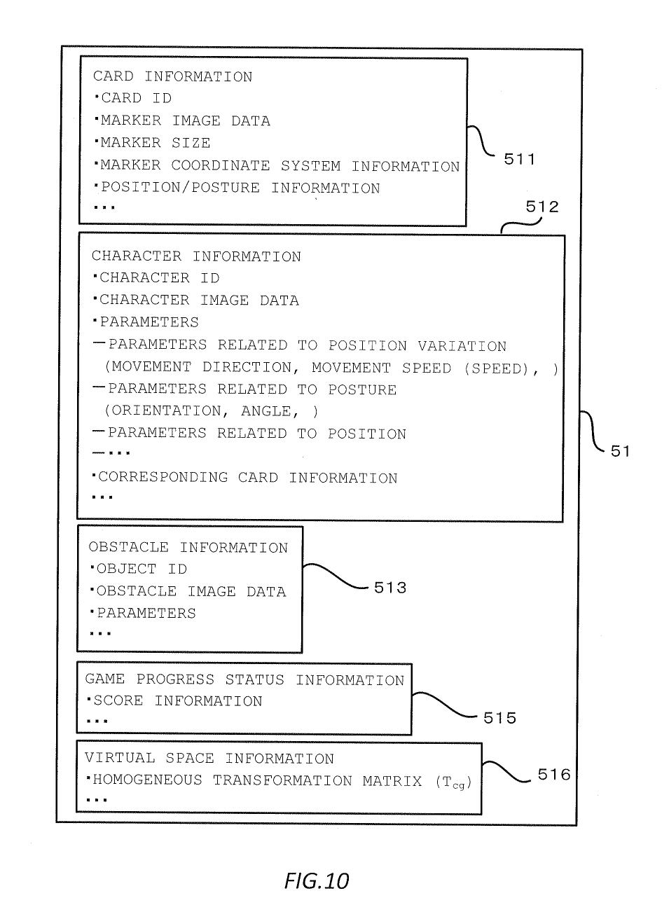

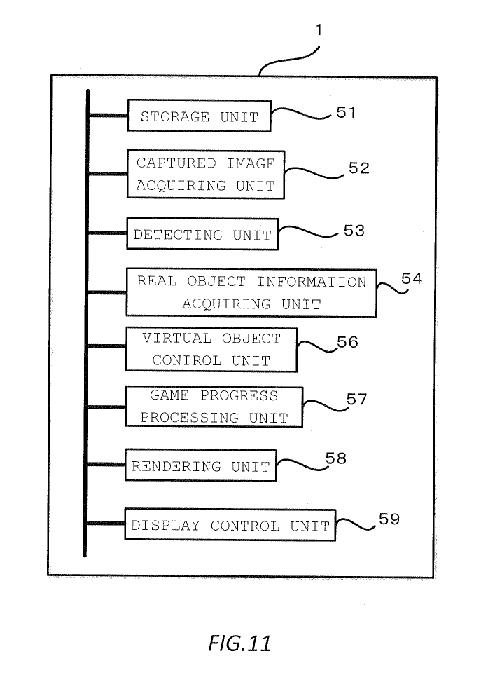

FIG. 10 illustrates information retained by the game device 1 according to the modification. In the present modification, information retained by a storage unit 51 includes card information 511, character information 512, obstacle information 513, game progress status information 515, and virtual space information 516. The respective types of information are as described earlier.

FIG. 11 illustrates function blocks of the game device 1 according to the modification. The respective function blocks shown in FIG. 11 represent parts of functions that are realized by the information processing unit 31 (the CPU 311 and the GPU 312) by, for example, reading and executing a game program stored in the external memory 45.

By executing the game program, the game device 1 according to the modification operates as a storage unit 51, a captured image acquiring unit 52, a detecting unit 53, a real object information acquiring unit 54, a virtual object control unit 56, a game progress processing unit 57, a rendering unit 58, and a display control unit 59. Respective functions of the units are as described earlier.

FIG. 12 is a flow chart that illustrates a procedure of a virtual object control related process according to the modification. A flow of game processing according to the modification is similar to the flow of game processing according to the present embodiment shown in FIG. 8. However, the modification and the present embodiment differ from each other in the virtual object control related process in step 104. Hereinafter, the virtual object control related process according to the modification will be described with reference to FIG. 12.

In step 301, a posture of the character 4 in a correspondence relationship with the card 2a and the card 2b is controlled. As described earlier, the card 2a corresponds to a left foot of the character 4. In addition, the card 2b corresponds to a right foot of the character 4. The virtual object control unit 56 controls the left foot of the character 4 based a posture of the card 2a. In addition, the virtual object control unit 56 controls the right foot of the character 4 based a posture of the card 2b.

In this case, it is assumed that a value of a parameter related to an orientation of the left foot of the character 4 is defined by a marker coordinate system of the marker 3a. In addition, it is assumed that a value of a parameter related to an orientation of the right foot of the character 4 is defined by a marker coordinate system of the marker 3b. For example, it is assumed that directions of X axes of the respective marker coordinate systems represent orientations of the feet. In this case, the virtual object control unit 56 can identify an orientation of the left foot of the character 4 from posture information among position/posture information (T_{cma}) included in the card information 511. Therefore, the virtual object control unit 56 controls the orientation of the left foot of the character 4 using posture information among the position/posture information (T_{cma}) included in the card information 511. The same applies to the right foot of the character 4. The virtual object control unit 56 controls the orientation of the right foot of the character 4 using posture information among position/posture information (T_{cmb}) included in the card information 511.

In step 302, values of parameters other than the parameters related to the control performed in step 301 are updated. In the present modification, the parameters related to the control performed in step 301 are the parameter related to the orientation of the left foot of the character 4 and the parameter related to the orientation of the right foot of the character 4. The virtual object control unit 56 controls states other than the orientation of the left foot and the orientation of the right foot of the character 4 based on the orientation of the left foot and the orientation of the right foot of the character 4.

For example, the virtual object control unit 56 controls a movement direction of the character 4 based on the orientation of the left foot and the orientation of the right foot of the character 4. The virtual object control unit 56 updates a parameter related to the movement direction of the character 4 based on the orientation of the left foot and the orientation of the right foot of the character 4.

In this case, it is assumed that a value of the parameter related to the movement direction of the character 4 is defined by a marker coordinate system of the marker 3a. At this point, the virtual object control unit 56 obtains a posture (orientation of the right foot of the character 4) of the card 2b in a marker coordinate system (Xₘₐ, Yₘₐ, Zₘₐ) based on the position/posture information (T_{cma} and T_{cmb}) included in the respective pieces of card information 511. Subsequently, the virtual object control unit 56 updates the value of the parameter related to the movement direction of the character 4 included in the character information 512 based on the orientation of the left foot and the orientation of the right foot of the character 4 in the marker coordinate system (Xₘₐ, Yₘₐ, Zₘₐ). For example, the virtual object control unit 56 updates the value of the parameter related to the movement direction of the character 4 to a value indicating an intermediate direction of the orientation of the left foot and the orientation of the right foot of the character 4 in the marker coordinate system (Xₘₐ, Yₘₐ, Zₘₐ).

As shown, control of the character 4 in the present modification can be described in the same manner as the control of the character 4 when using relative posture information 514. For example, the virtual object control unit 56 can obtain a similarity and a difference between the orientation of the left foot and the orientation of the right foot of the character 4.

In addition, the virtual object control unit 56 can identify a position of the left foot and a position of the right foot of the character 4 based on the position/posture information (T_{cma} and T_{cmb}) included in the respective pieces of card information 511. Furthermore, the virtual object control unit 56 can obtain an opposing state of the left foot and the right foot of the character 4 from the position of the left foot, the orientation of the left foot, the position of the right foot, and the orientation of the right foot of the character 4.

The virtual object control unit 56 can respectively utilize a similarity and a difference between the orientation of the left foot and the orientation of the right foot of the character 4 as well as an opposing state of the left foot and the right foot of the character 4 which can be obtained as described earlier in place of similarity information, difference information, and opposing state information included in relative posture information according to the present embodiment. As such, a description of other examples of the control by the virtual object control unit 56 will be omitted.

However, processing by the game device 1 according to the modification is not limited to those using a similarity, a difference, and an opposing state of the left and right feet of the character 4. For example, a table, a map, a function, or the like may be prepared in which information related to orientations of the left and right feet are associated with postures, movement directions, movement speeds, falling conditions, and the like of the character 4. In addition, the virtual object control unit 56 may control the character 4 using information on the orientations of the left and right feet of the character 4 obtained from the card 2a and the card 2b, and the table, the map, the function, or the like described above.

In step 303, arrangement positions of virtual objects such as the character 4 and the obstacle 5 are updated. Step 303 is similar to step 203.

In the present modification, for example, a movement direction, a movement speed, and the like of the character 4 are controlled by postures of two cards 2 in the same manner as in the present embodiment. Therefore, even with the present modification, when controlling the character 4 using the marker 3, control of the character 4 can be performed in wider variations in the same manner as in the present embodiment.

### §4 Application Examples

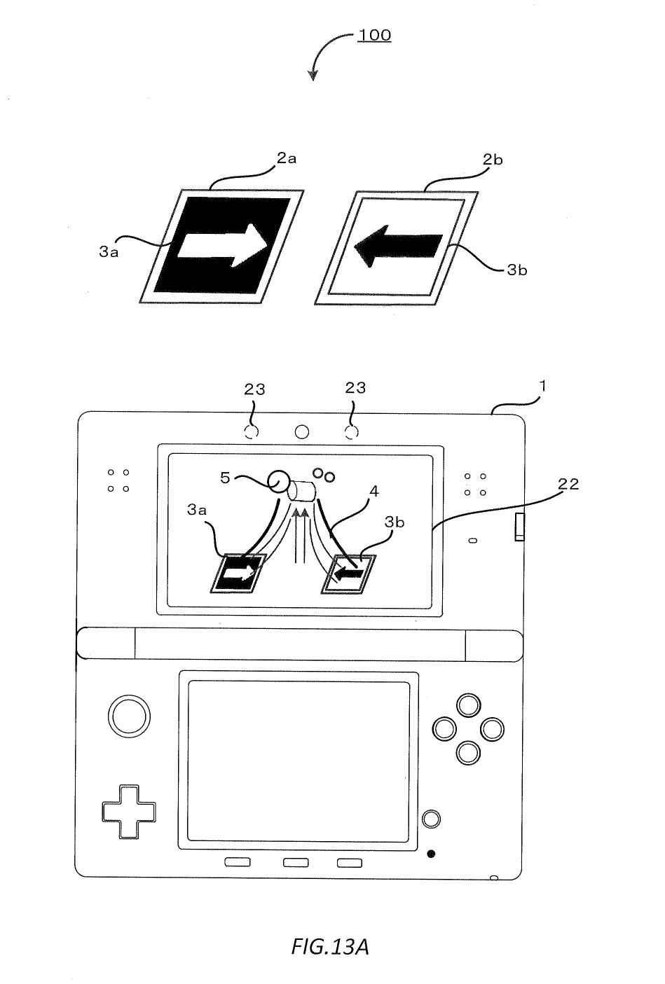

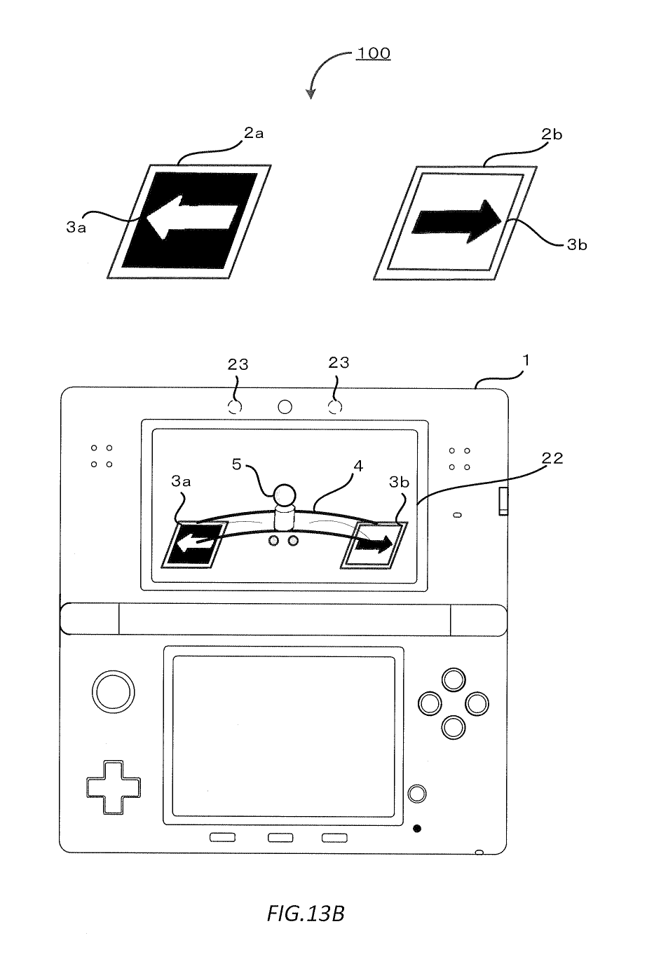

FIGS. 13A and 13B show an application example of the game system 100 according to the present embodiment. For example, the game system 100 according to the present embodiment can provide a player with a game of manipulating an air current 4 such as that shown in FIGS. 13A and 13B.

In the present game, the air current 4 is an virtual object that becomes a manipulation object of the player. In addition, a character 5 is a virtual object other than the manipulation object of the player. The virtual object control unit 56 controls the air current 4 according to a posture of a card 2. Furthermore, the character 5 is moved by the air current 4 controlled according to a posture of the card 2.

For example, the virtual object control unit 56 controls a wind speed of the air current 4 according to a similarity of a posture of the card 2 indicated by similarity information included in relative posture information 514. As a specific example, the virtual object control unit 56 controls the wind speed of the air current 4 so that the higher the similarity of the posture of the card 2 indicated by similarity information included in the relative posture information 514, the greater the wind speed. In this case, the higher the wind speed of the air current 4, the faster the character 5 is moved.

In addition, for example, the virtual object control unit 56 controls a type of the air current 4 according to an opposing state indicated by opposing state information included in the relative posture information 514. A specific example is shown in FIGS. 13A and 13B. When the opposing state information indicates that the postures of the card 2a and the card 2b are in an opposing state (FIG. 13A), the virtual object control unit 56 sets the air current 4 to an updraft. In this case, the character 5 is moved upward by the air current 4. Furthermore, in another case (FIG. 13B), the air current 4 is set to an air current flowing toward a center of the card 2. In this case, the character 5 is moved toward the center of the card 2. Moreover, for example, the virtual object control unit 56 may set the wind speed of the air current 4 so that the shorter a distance between the card 2a and the card 2b, the higher the wind speed.

FIGS. 14A and 14B show another application example of the game system 100 according to the present embodiment. For example, the game system 100 according to the present embodiment can provide a player with a game of manipulating a quadline kite 4 such as that shown in FIGS. 14A and 14B.

For example, the virtual object control unit 56 controls a flight direction of the quadline kite 4 according to similarity information included in the relative posture information 514. As a specific example, the virtual object control unit 56 identifies two cards 2 related to a highest similarity from the similarity information included in the relative posture information 514. In addition, the virtual object control unit 56 controls a flight direction of the quadline kite 4 so that the quadline kite 4 exists in a direction of the two identified cards 2 (refer to FIGS. 14A and 14B).

Furthermore, for example, the virtual object control unit 56 controls a flight state of the quadline kite 4 according to difference information included in the relative posture information 514. As a specific example, the virtual object control unit 56 obtains a sum of differences among the respective cards 2 from difference information included in the relative posture information 514. When the sum of differences exceeds a predetermined value, the virtual object control unit 56 causes the quadline kite 4 to execute a crashing action.

While certain example systems, methods, devices and apparatuses have been described herein, it is to be understood that the appended claims are not to be limited to the systems, methods, devices and apparatuses disclosed, but on the contrary, are intended to cover various modifications and equivalent arrangements included within the spirit and scope of the appended claims.

What is claimed is:

1. An information processing system comprising a plurality of real objects each having a feature and an information processing device connected to a display device and an imaging device, wherein
the feature is a feature which enables at least a posture of the real object with respect to the imaging device to be identified by being captured by the imaging device, and
the information processing device includes:
a captured image acquiring unit which acquires a captured image that is captured by the imaging device;
a detecting unit which detects the respective features of the plurality of real objects from the captured image;
a real object information acquiring unit which acquires a plurality of pieces of real object information including posture information that indicates respective postures of the plurality of real objects, based on the detected features;
a virtual object control unit which controls a single virtual object in a virtual space based on the plurality of pieces of real object information; and
a display control unit which causes the display device to display an image including at least the single virtual object.

2. The information processing system according to claim 1, wherein
the information processing device further includes a relative posture information acquiring unit which acquires relative posture information indicating a relative posture relationship among the plurality of real objects from the plurality of pieces of real object information, and
the virtual object control unit controls the single virtual object based on the relative posture information.

3. The information processing system according to claim 2, wherein the virtual object control unit changes a value of a parameter related to a state of the single virtual object based on the relative posture information.

4. The information processing system according to claim 3, wherein the parameter related to the state of the single virtual object whose value is changed by the virtual object control unit at least includes a parameter related to a position variation of the single virtual object in the virtual space.

5. The information processing system according to claim 4, wherein the virtual object control unit varies a relative position of the single virtual object with respect to the virtual space based on a value of the parameter related to the position variation of the single virtual object.

6. The information processing system according to claim 4, wherein the parameter related to the position variation of the single virtual object in the virtual space whose value is changed by the virtual object control unit at least includes parameters related to a movement direction and a movement speed of the single virtual object.

7. The information processing system according to claim 2, wherein the relative posture information acquiring unit acquires the relative posture information including information related to a similarity of posture between two real objects among the plurality of real objects.

8. The information processing system according to claim 2, wherein the relative posture information acquiring unit acquires the relative posture information including information related to a difference in posture between two real objects among the plurality of real objects.

9. The information processing system according to claim 2, wherein
the feature is a feature which enables a position and a posture of the real object with respect to the imaging device to be identified by being captured by the imaging device, and
the real object information acquiring unit acquires a plurality of pieces of real object information including position/posture information that indicates respective positions and postures of the plurality of real objects, based on the detected feature.

10. The information processing system according to claim 9, wherein the relative posture information acquiring unit acquires the relative posture information including information indicating an opposing state identified from positions and postures of at least two real objects among the plurality of real objects.

11. The information processing system according to claim 10, wherein the relative posture information acquiring unit identifies the opposing state using an inner product value of vectors related to postures of two real objects among the at least two real objects and an inner product value of a vector related to a posture of one real object of the two real objects and a relative position vector indicating a relative position relationship of the two real objects.

12. The information processing system according to claim 1, wherein the virtual object control unit controls, based on the plurality of pieces of real object information, a posture indicated by values of a plurality of parameters related to the posture of the single virtual object and each having a correspondence relationship with each of the plurality of pieces of real object information.

13. The information processing system according to claim 12, wherein when controlling the single virtual object, the virtual object control unit changes, based on a posture of the single virtual object indicated by the values of the plurality of parameters related to the posture, a value of a parameter which is different from the plurality of parameters related to the posture and which relates to other states.

14. The information processing system according to claim 13, wherein the parameter related to other states is a parameter related to a position variation in the virtual space.

15. The information processing system according to claim 14, wherein the virtual object control unit varies a relative position of the single virtual object with respect to the virtual space based on a value of the parameter related to the position variation of the single virtual object.

16. The information processing system according to claim 12, wherein
the feature is a feature which enables a position and a posture of the real object with respect to the imaging device to be identified by being captured by the imaging device, and
the real object information acquiring unit acquires a plurality of pieces of real object information including position/posture information that indicates respective positions and postures of the plurality of real objects.

17. The information processing system according to claim 9, wherein the information processing device further includes a rendering unit which renders a virtual space image by setting a position and a posture of a virtual camera arranged in the virtual space, arranging, in the virtual space, the single virtual object whose position and posture are determined by the plurality of pieces of real object information, and generating an image of the virtual space as seen from the virtual camera.

18. The information processing system according to claim 17, wherein the display control unit generates a composite image in which the virtual space image is superimposed on the captured image, and causes the display device to display the composite image.

19. An information processing device comprising:
a captured image acquiring unit which acquires a captured image that is captured by an imaging device;
a detecting unit which detects, from the captured image, a feature of each of a plurality of real objects, the feature enabling at least a posture of the real object with respect to the imaging device to be identified by being captured by the imaging device;
a real object information acquiring unit which acquires a plurality of pieces of real object information including posture information that indicate respective postures of the plurality of real objects, based on the detected feature;
a virtual object control unit which controls a single virtual object in a virtual space based on the plurality of pieces of real object information; and
a display control unit which causes a display device to display an image including at least the single virtual object.

20. An information processing method that causes a computer to:
acquire a captured image that is captured by an imaging device;
detect, from the captured image, a feature of each of a plurality of real objects, the feature enabling at least a posture of the real object with respect to the imaging device to be identified by being captured by the imaging device;
acquire a plurality of pieces of real object information including posture information that indicate respective postures of the plurality of real objects, based on the detected feature;
control a single virtual object in a virtual space based on the plurality of pieces of real object information; and
cause a display device to display an image including at least the single virtual object.

21. A computer-readable recording medium on which is recorded an information processing program for causing a computer to:
acquire a captured image that is captured by an imaging device;
detect, from the captured image, a feature of each of a plurality of real objects, the feature enabling at least a posture of the real object with respect to the imaging device to be identified by being captured by the imaging device;
acquire a plurality of pieces of real object information including posture information that indicate respective postures of the plurality of real objects, based on the detected feature;
control a single virtual object in a virtual space based on the plurality of pieces of real object information; and
cause a display device to display an image including at least the single virtual object.
